(19) United States
(12) Patent Application Publication
(10) Pub. No.: US 2026/0116814 A1
(43) Pub. Date: Apr. 30, 2026

(54) PRECURSOR GLASSES, COLORED GLASS-CERAMICS FORMED THEREFROM, AND METHODS OF FORMING THE SAME

(71) Applicant: CORNING INCORPORATED, CORNING, NY (US)

(72) Inventors: Carol Ann Click, Corning, NY (US); Gilbert De Angelis, Lindley, NY (US); Megan Aurora DeLamielleure, Corning, NY (US); Xiaoju Guo, Pittsford, NY (US); Alana Kapusta, Corning, NY (US); George Karl Kaufman, Painted Post, NY (US); Po Hsuen Kuo, Painted Post, NY (US); Adam Robert Sarafian, Corning, NY (US); Emily Kathryn Sarafian, Corning, NY (US); Madeleine Tang Schmidlin, Elmira, NY (US); Lisa Anne Tietz Moore, Corning, NY (US); Nicholas John Tostanoski, Painted Post, NY (US); Alana Marie Whittier, Painted Post, NY (US); Joseph Martin Wright, Corning, NY (US)

(21) Appl. No.: 19/363,094

(22) Filed: Oct. 20, 2025

Related U.S. Application Data
(60) Provisional application No. 63/712,181, filed on Oct. 25, 2024.

(51) Int. Cl. C03C 10/00; C03B 5/235; C03C 4/02

(52) U.S. Cl. CPC C03C 10/0027; C03B 5/2353; C03C 4/02; C03B 2211/40

(57) ABSTRACT

Disclosed herein are glass-ceramics that may include a phase assemblage including: 35 wt % to 60 wt % of a petalite crystalline phase; 20 wt % to 60 wt % of a lithium disilicate crystalline phase; and 5 wt % to 20 wt % of a residual amorphous glass phase. The glass-ceramics may further include copper metal nanoparticles dispersed in the residual amorphous glass phase. The glass-ceramics may appear red in color and comprises transmittance color coordinates in CIE LAB color space of: L* greater than or equal to 0 and less than or equal to 100; a* greater than or equal to −23 and less than or equal to 62; and b* greater than or equal to −10 and less than or equal to 60.5 at an article thickness of 0.55 mm for a CIE illuminant D65 under SCI UVC conditions and a 10 degree observer angle.

### CROSS REFERENCE TO RELATED APPLICATION

This application claims the benefit of priority under 35 U.S.C. § 119 of U.S. Provisional Application Ser. No. 63/712,181 filed on Oct. 25, 2024, the content of which is relied upon and incorporated herein by reference in its entirety.

### FIELD

The present specification generally relates to precursor glasses and colored glass-ceramics formed therefrom and, more particularly, to glass-ceramics comprising a red color.

### TECHNICAL BACKGROUND

There is a demand for high strength glass-based articles that may be used in conjunction with, for example, portable electronic devices. Several materials are currently utilized on the market such as glass, zirconia, plastic, metal, and glass-ceramics. Glass-ceramics have certain advantages over other materials, including high strength and fracture toughness.

Various industries, including the consumer electronics industry, desire colored materials with the same or similar strength and fracture toughness properties as highly transparent glass-ceramics. However, simply including colorants in conventional glass-ceramic materials may not produce the desired color.

Accordingly, a need exists for glass-ceramics capable of achieving a desired color.

### SUMMARY

According to a first aspect A1, a glass-ceramic may include a phase assemblage comprising: 35 wt % to 60 wt % of a petalite crystalline phase; 20 wt % to 60 wt % of a lithium disilicate crystalline phase; and 5 wt % to 20 wt % of a residual amorphous glass phase; and copper metal nanoparticles dispersed in the residual amorphous glass phase, wherein the glass-ceramic appears red in color and comprises transmittance color coordinates in CIE LAB color space of: L* greater than or equal to 0 and less than or equal to 100; a* greater than or equal to −23 and less than or equal to 62; and b* greater than or equal to −10 and less than or equal to 60.5 at an article thickness of 0.55 mm for a CIE illuminant D65 under SCI UVC conditions and a 10 degree observer angle.

A second aspect A2 includes the glass-ceramic of aspect A1, wherein a size distribution of the copper metal nanoparticles in the glass-ceramic is such that a peak position of a largest dimension of the copper metal nanoparticles is in the range from greater than or equal to 20 nm to less than or equal to 40 nm.

A third aspect A3 includes the glass-ceramic of any of aspects A1-A2, wherein the glass-ceramic is formed from a precursor glass comprising: greater than or equal to 65 wt % and less than or equal to 80 wt % SiO₂; greater than or equal to 1 wt % and less than or equal to 15 wt % Al₂O₃; greater than or equal to 8 wt % and less than or equal to 15 wt % Li₂O; greater than or equal to 1 wt % and less than or equal to 4 wt % P₂O₅; greater than or equal to 2 wt % and less than or equal to 12 wt % ZrO₂; greater than or equal to 0.01 wt % and less than or equal to 0.6 wt % SnO; and greater than or equal to 0.01 wt % and less than or equal to 2.0 wt % Cu₂O.

A fourth aspect A4 includes the glass-ceramic of aspect A3, wherein the precursor glass comprises greater than 0 wt % and less than or equal to 2 wt % CaO.

A fifth aspect A5 includes the glass-ceramic of any of aspects A3-A4, wherein the precursor glass comprises than 0 wt % and less than or equal to 1 wt % K₂O.

A sixth aspect A6 includes the glass-ceramic of any of aspects A3-A5, wherein the precursor glass comprises greater than 0 wt % and less than or equal to 1 wt % Na₂O.

A seventh aspect A7 includes the glass-ceramic of any of aspects A3-A6, wherein the precursor glass comprises greater than or equal to 0.01 wt % to less than or equal to 2 wt % CuO.

An eighth aspect A8 includes the glass-ceramic of any of aspects A3-A7, wherein the precursor glass is free of CuO.

A ninth aspect A9 includes the glass-ceramic of any of aspects A3-A8, wherein the precursor glass comprises on optical basicity of greater than or equal to 0.47 and less than or equal to 0.49.

A tenth aspect A10 includes the glass-ceramic of any of aspects A1-A9, wherein the phase assemblage further comprises less than 10 wt % lithium metasilicate.

According to an eleventh aspect A11, a method of forming a colored glass-ceramic may include: flowing oxygen and fuel to a burner of a melter and combusting the oxygen and the fuel to heat the melter, wherein a ratio of oxygen to fuel is less than 2.7:1 and greater than or equal to 1.8:1; heating glass batch materials in the melter to form molten glass; forming the molten glass into a precursor glass with a forming apparatus, wherein the precursor glass comprises: greater than or equal to 65 wt % and less than or equal to 80 wt % SiO₂; greater than or equal to 1 wt % and less than or equal to 15 wt % Al₂O₃; greater than or equal to 8 wt % and less than or equal to 15 wt % Li₂O; greater than or equal to 1 wt % and less than or equal to 4 wt % P₂O₅; greater than or equal to 2 wt % and less than or equal to 12 wt % ZrO₂; greater than or equal to 0.01 wt % and less than or equal to 0.6 wt % SnO; and greater than or equal to 0.01 wt % and less than or equal to 2.0 wt % Cu₂O; and ceramming the precursor glass into a glass-ceramic.

A twelfth aspect A12 includes the method of aspect A11, wherein the precursor glass comprises greater than 0 wt % and less than or equal to 2 wt % CaO.

A thirteenth aspect A13 includes the method of any of aspects A11-A12, wherein the precursor glass comprises than 0 wt % and less than or equal to 1 wt % K₂O.

A fourteenth aspect A14 includes the method of any of aspects A11-A13, wherein the precursor glass comprises greater than 0 wt % and less than or equal to 1 wt % Na₂O.

A fifteenth aspect A15 includes the method of any of aspects A11-A14, wherein the precursor glass comprises greater than or equal to 0.01 wt % to less than or equal to 2 wt % CuO.

A sixteenth aspect A16 includes the method of any of aspects A11-A15, wherein the precursor glass is free of CuO.

A seventeenth aspect A17 includes the method of any of aspects A11-A16, wherein the precursor glass comprises on optical basicity of greater than or equal to 0.47 and less than or equal to 0.49.

A eighteenth aspect A18 includes the method of any of aspects A11-A17, wherein the glass-ceramic comprises a phase assemblage comprising: 35 wt % to 60 wt % of a petalite crystalline phase; 20 wt % to 60 wt % of a lithium disilicate crystalline phase; and 5 wt % to 20 wt % of a residual amorphous glass phase; and copper metal nanoparticles dispersed in the residual amorphous glass phase.

A nineteenth aspect A19 includes the method of aspect A18, wherein a size distribution of the copper metal nanoparticles in the glass-ceramic is such that a peak position of a largest dimension of the copper metal nanoparticles is in the range from greater than or equal to 20 nm to less than or equal to 40 nm.

A twentieth aspect A20 includes the method of any of aspects A11-A19, wherein the glass-ceramic appears red in color and comprises transmittance color coordinates in CIE LAB color space of: L* greater than or equal to 0 and less than or equal to 100; a* greater than or equal to −23 and less than or equal to 62; and b* greater than or equal to −10 and less than or equal to 60.5 at an article thickness of 0.55 mm for a CIE illuminant D65 under SCI UVC conditions and a 10 degree observer angle.

Additional features and advantages of the precursor glasses and glass-ceramics described herein will be set forth in the detailed description which follows, and in part will be readily apparent to those skilled in the art from that description or recognized by practicing the embodiments described herein, including the detailed description which follows, the claims, as well as the appended drawings.

It is to be understood that both the foregoing general description and the following detailed description describe various embodiments and are intended to provide an overview or framework for understanding the nature and character of the claimed subject matter. The accompanying drawings are included to provide a further understanding of the various embodiments, and are incorporated into and constitute a part of this specification. The drawings illustrate the various embodiments described herein, and together with the description serve to explain the principles and operations of the claimed subject matter.

### BRIEF DESCRIPTION OF THE DRAWINGS

FIG. 1 is a flow chart that depicts methods according to embodiments disclosed and described herein;

FIG. 2 schematically depicts a cross section of a glass-ceramic article that has been chemically strengthened by ion exchange treatment;

FIG. 3A schematically depicts a top view of an electronic device including a glass-ceramic article according to embodiments disclosed and described herein;

FIG. 3B schematically depicts a perspective view of an electronic device including a glass-ceramic article according to embodiments disclosed and described herein;

FIG. 4 schematically depicts a glass manufacturing apparatus according to one or more embodiments shown and described herein; and

FIG. 5 graphically depicts the amount of blister defects per unit volume (Y axis) as for glass batch materials of different compositions.

### DETAILED DESCRIPTION

Reference will now be made in detail to embodiments of precursor glasses and colored glass-ceramics formed therefrom, examples of which are illustrated in the accompanying drawing. Whenever possible, the same reference numerals will be used throughout the drawings to refer to the same or like parts. In embodiments, a colored glass-ceramic may include a phase assemblage including: 35 wt % to 60 wt % of a petalite crystalline phase; 20 wt % to 60 wt % of a lithium disilicate crystalline phase; and 5 wt % to 20 wt % of a residual amorphous glass phase. The glass-ceramics may further include copper metal nanoparticles dispersed in the residual amorphous glass phase. The glass-ceramics may appear red in color and comprises transmittance color coordinates in CIE LAB color space of: L* greater than or equal to 0 and less than or equal to 100; a* greater than or equal to −23 and less than or equal to 62; and b* greater than or equal to −10 and less than or equal to 60.5 at an article thickness of 0.55 mm for a CIE illuminant D65 under SCI UVC conditions and a 10 degree observer angle. Various embodiments of precursor glasses and colored glass-ceramics formed therefrom, and methods for forming the same will be described in further detail herein with particular reference to the appended drawings.

As used herein, the term “glass-ceramic” refers to solids prepared by controlled crystallization of a precursor glass and have one or more crystalline phases and a residual amorphous glass phase.

As used herein, “depth of compression” or “DOC” refers to the depth of a compressive stress (CS) layer and is the depth at which the stress within a glass-ceramic article changes from compressive stress to tensile stress and has a stress value of zero. According to the convention normally used in the art, compressive stress is expressed as a negative (<0) stress and tensile stress is expressed as a positive (>0) stress. Throughout this description, however, and unless otherwise noted, CS is expressed as a positive or absolute value—that is, as recited herein, CS=|CS|.

The CS, DOC, and maximum central tension (CT) values are measured using a hybrid method that combines measurements made using evanescent prism coupling spectroscopy (EPCS) and light scattering polarimetry (LSP) as disclosed in U.S. Patent Application Publication No. 2020/0300615, which is incorporated herein by reference in its entirety.

Optical transmission (also referred to herein as “transmittance”) is measured in the 250-1000 nm range on optically polished samples with plane parallel faces using a Perkin Elmer Lambda 950 spectrophotometer, with data interval of 2 nm. The transmission is measured on the glass-ceramic article itself without any coatings or other applications.

X-ray diffraction (XRD) is conducted on powdered samples using a Bruker D4 Endeavor equipped with Cu radiation and a LynxEye detector. The phase assemblage is determined using Rietveld method and using Bruker's Topas software package.

The terms “free” and “substantially free,” when used to describe the concentration and/or absence of a particular constituent component in a precursor glass or glass-ceramic, means that the constituent component is not intentionally added to the precursor glass or glass-ceramic. However, the precursor glass or glass-ceramic may contain traces of the constituent component as a contaminant or tramp in amounts of less than 0.01 wt %.

The term “CIELAB color space,” as used herein, refers to a color space defined by the International Commission on Illumination (CIE) in 1976. It expresses color as three values: L* for the lightness from black (0) to white (100), a* from green (−) to red (+), and B* from blue (−) to yellow (+).

The term “color gamut,” as used herein, refers to the pallet of colors that may be achieved by the colored glass articles within the CIELAB color space.

The “optical transmission spectra,” as used herein, were obtained using Konica Minolta® CM3700A colorimeter with a scan range of 360 nm to 740 nm, a scan step of 1 nm, and a spot size of 5 mm and converted with SpectraMagix NX2® software. The optical transmission data obtained were used to plot coordinates in the CIELAB color space as described in R. S. Berns, Billmeyer and Saltzman's Principles of Color Technology, 3rd. Ed., John Wiley & Sons, New York (2000).

The size of the copper metal nanoparticles in the glass-ceramic are measured by image analysis of images of the glass-ceramic captured with a Zeiss Gemini 450 Scanning Electron Microscope and analyzed with ImageJ® software to determine the largest dimension of each copper metal nanoparticle in the captured image. Thereafter, a size distribution of the copper metal nanoparticles is obtained.

Ranges can be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

Directional terms as used herein—for example up, down, right, left, front, back, top, bottom—are made only with reference to the figures as drawn and are not intended to imply absolute orientation.

Unless otherwise expressly stated, it is in no way intended that any method set forth herein be construed as requiring that its steps be performed in a specific order, nor that with any apparatus specific orientations be required. Accordingly, where a method claim does not actually recite an order to be followed by its steps, or that any apparatus claim does not actually recite an order or orientation to individual components, or it is not otherwise specifically stated in the claims or description that the steps are to be limited to a specific order, or that a specific order or orientation to components of an apparatus is not recited, it is in no way intended that an order or orientation be inferred, in any respect. This holds for any possible non-express basis for interpretation, including: matters of logic with respect to arrangement of steps, operational flow, order of components, or orientation of components; plain meaning derived from grammatical organization or punctuation, and the number or type of embodiments described in the specification.

As used herein, the singular forms “a,” “an” and “the” include plural referents unless the context clearly dictates otherwise. Thus, for example, reference to “a” component includes aspects having two or more such components, unless the context clearly indicates otherwise.

Glass-ceramics have attributes making them amenable for use as cover substrates and/or housings for mobile electronic devices. For example, without being bound by theory, glass-ceramics with high fracture toughness and/or Young's modulus can provide resistance to crack penetration and exhibit good drop performance. When such glass-ceramics are chemically strengthened, for example through ion exchange, the resistance to crack penetration and drop performance can be further enhanced. The high fracture toughness and/or Young's modulus may also increase the amount of stored tensile energy and maximum central tension that can be imparted to the glass-ceramics through chemical tempering (e.g., through ion exchange strengthening). In addition, the optical characteristics of the glass-ceramics, such as transparency and haze, can be tailored by adjusting the heating/ceramming schedule used to transform the precursor glass into glass-ceramic.

Various industries, including the consumer electronics industry, desire colored materials with the same or similar strength and fracture toughness properties as highly transparent glass-ceramics. However, simply including colorants in conventional glass-ceramic materials may not produce the desired color.

Described herein are glass-ceramics comprising copper metal nanoparticles and having a desired red color. Also disclosed are methods of forming the glass-ceramics to include the copper metal nanoparticles and, as a result, the desired red color.

In various embodiments, the composition of the precursor glass is selected such that the resultant glass-ceramic has a phase assemblage comprising a petalite crystalline phase and a lithium silicate crystalline phase, specifically a lithium disilicate crystalline phase, wherein the petalite crystalline phase and the lithium disilicate crystalline phase have higher weight percentages than other crystalline phases present in the glass-ceramic article. The phase assemblage further includes a residual amorphous glass phase. The glass-ceramics described herein further comprise copper metal nanoparticles dispersed in the residual amorphous glass phase. The copper metal nanoparticles impart a red color to the glass-ceramic.

The petalite (LiAlSi₄O₁₀) of the petalite crystalline phase is a monoclinic crystal possessing a three-dimensional framework structure with a layered structure having folded Si₂O₅ layers linked by Li and A1 tetrahedra. The Li is in tetrahedral coordination with oxygen. The mineral petalite is a lithium source and is used as a low thermal expansion phase to improve the thermal downshock resistance of glass-ceramics or ceramic parts.

In embodiments of the glass-ceramics described herein, the weight percentage of the petalite crystalline phase in the glass-ceramics can be in a range from greater than or equal to 20 to less than or equal to 70 wt %, greater than or equal to 20 to less than or equal to 65 wt %, greater than or equal to 20 to less than or equal to 60 wt %, greater than or equal to 20 to less than or equal to 55 wt %, greater than or equal to 20 to less than or equal to 50 wt %, greater than or equal to 20 to less than or equal to 45 wt %, greater than or equal to 20 to less than or equal to 40 wt %, greater than or equal to 20 to less than or equal to 35 wt %, greater than or equal to 20 to less than or equal to 30 wt %, greater than or equal to 20 to less than or equal to 25 wt %, greater than or equal to 25 to less than or equal to 70 wt %, greater than or equal to 25 to less than or equal to 65 wt %, greater than or equal to 25 to less than or equal to 60 wt %, greater than or equal to 25 to less than or equal to 55 wt %, greater than or equal to 25 to less than or equal to 50 wt %, greater than or equal to 25 to less than or equal to 45 wt %, greater than or equal to 25 to less than or equal to 40 wt %, greater than or equal to 25 to less than or equal to 35 wt %, greater than or equal to 25 to less than or equal to 30 wt %, greater than or equal to 30 to less than or equal to 70 wt %, greater than or equal to 30 to less than or equal to 65 wt %, greater than or equal to 30 to less than or equal to 60 wt %, greater than or equal to 30 to less than or equal to 55 wt %, greater than or equal to 30 to less than or equal to 50 wt %, greater than or equal to 30 to less than or equal to 45 wt %, greater than or equal to 30 to less than or equal to 40 wt %, greater than or equal to 30 to less than or equal to 35 wt %, greater than or equal to 35 to less than or equal to 70 wt %, greater than or equal to 35 to less than or equal to 65 wt %, greater than or equal to 35 to less than or equal to 60 wt %, greater than or equal to 35 to less than or equal to 55 wt %, greater than or equal to 35 to less than or equal to 50 wt %, greater than or equal to 35 to less than or equal to 45 wt %, greater than or equal to 35 to less than or equal to 40 wt %, greater than or equal to 40 to less than or equal to 70 wt %, greater than or equal to 40 to less than or equal to 65 wt %, greater than or equal to 40 to less than or equal to 60 wt %, greater than or equal to 40 to less than or equal to 55 wt %, greater than or equal to 40 to less than or equal to 50 wt %, greater than or equal to 40 to less than or equal to 45 wt %, greater than or equal to 45 to less than or equal to 70 wt %, greater than or equal to 45 to less than or equal to 65 wt %, greater than or equal to 45 to less than or equal to 60 wt %, greater than or equal to 45 to less than or equal to 55 wt %, greater than or equal to 45 to less than or equal to 50 wt %, greater than or equal to 50 to less than or equal to 70 wt %, greater than or equal to 50 to less than or equal to 65 wt %, greater than or equal to 50 to less than or equal to 60 wt %, greater than or equal to 50 to less than or equal to 55 wt %, greater than or equal to 55 to less than or equal to 70 wt %, greater than or equal to 55 to less than or equal to 65 wt %, greater than or equal to 55 to less than or equal to 60 wt %, greater than or equal to 60 to less than or equal to 70 wt %, greater than or equal to 60 to less than or equal to 65 wt %, or even greater than or equal to 65 to less than or equal to 70 wt %. It should be understood that the above ranges include all subranges within the explicitly disclosed ranges. In embodiments, the glass-ceramics may comprise about 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, or 70 wt % of the petatlite crystalline phase.

The lithium disilicate (Li₂Si₂O₅) of the lithium disilicate crystalline phase is an orthorhombic crystal based on corrugated sheets of {Si₂O₅} tetrahedral arrays. The crystals are typically tabular or lath-like in shape, with pronounced cleavage planes. Glass-ceramics based on lithium disilicate offer highly desirable mechanical properties, including high body strength and fracture toughness, due to their microstructure of randomly oriented interlocked crystals—a crystal structure that forces cracks to propagate through the material via tortuous paths around these crystals.

In embodiments, the weight percentage of the lithium disilicate crystalline phase (also referred to herein as “L2S”) in the glass-ceramics can be in a range from greater than or equal to 20 to less than or equal to 60 wt %, greater than or equal to 20 to less than or equal to 55 wt %, greater than or equal to 20 to less than or equal to 50 wt %, greater than or equal to 20 to less than or equal to 45 wt %, greater than or equal to 20 to less than or equal to 40 wt %, greater than or equal to 20 to less than or equal to 35 wt %, greater than or equal to 20 to less than or equal to 30 wt %, greater than or equal to 20 to less than or equal to 25 wt %, greater than or equal to 25 to less than or equal to 60 wt %, greater than or equal to 25 to less than or equal to 55 wt %, greater than or equal to 25 to less than or equal to 50 wt %, greater than or equal to 25 to less than or equal to 45 wt %, greater than or equal to 25 to less than or equal to 40 wt %, greater than or equal to 25 to less than or equal to 35 wt %, greater than or equal to 25 to less than or equal to 30 wt %, greater than or equal to 30 to less than or equal to 60 wt %, greater than or equal to 30 to less than or equal to 55 wt %, greater than or equal to 30 to less than or equal to 50 wt %, greater than or equal to 30 to less than or equal to 45 wt %, greater than or equal to 30 to less than or equal to 40 wt %, greater than or equal to 30 to less than or equal to 35 wt %, greater than or equal to 35 to less than or equal to 60 wt %, greater than or equal to 35 to less than or equal to 55 wt %, greater than or equal to 35 to less than or equal to 50 wt %, greater than or equal to 35 to less than or equal to 45 wt %, greater than or equal to 35 to less than or equal to 40 wt %, greater than or equal to 40 to less than or equal to 60 wt %, greater than or equal to 40 to less than or equal to 55 wt %, greater than or equal to 40 to less than or equal to 50 wt %, greater than or equal to 40 to less than or equal to 45 wt %, greater than or equal to 45 to less than or equal to 60 wt %, greater than or equal to 45 to less than or equal to 55 wt %, greater than or equal to 45 to less than or equal to 50 wt %, greater than or equal to 50 to less than or equal to 60 wt %, greater than or equal to 50 to less than or equal to 55 wt %, or even greater than or equal to 55 to less than or equal to 60 wt %. It should be understood that the above ranges include all subranges within the explicitly disclosed ranges. In embodiments, the glass-ceramic may comprise about 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, or 60 wt % of the lithium disilicate crystalline phase.

In embodiments, the content of the residual amorphous glass phase in the glass-ceramics is greater than or equal to 5 wt % and less than or equal to 20 wt %, greater than or equal to 6 wt % and less than or equal to 20 wt %, greater than or equal to 7 wt % and less than or equal to 20 wt %, greater than or equal to 8 wt % and less than or equal to 20 wt %, greater than or equal to 9 wt % and less than or equal to 20 wt %, greater than or equal to 10 wt % and less than or equal to 20 wt %, greater than or equal to 5 wt % and less than or equal to 18 wt %, greater than or equal to 6 wt % and less than or equal to 18 wt %, greater than or equal to 7 wt % and less than or equal to 18 wt %, greater than or equal to 8 wt % and less than or equal to 18 wt %, greater than or equal to 9 wt % and less than or equal to 18 wt %, greater than or equal to 10 wt % and less than or equal to 18 wt %, greater than or equal to 5 wt % and less than or equal to 16 wt %, greater than or equal to 6 wt % and less than or equal to 16 wt %, greater than or equal to 7 wt % and less than or equal to 16 wt %, greater than or equal to 8 wt % and less than or equal to 16 wt %, greater than or equal to 9 wt % and less than or equal to 16 wt %, greater than or equal to 10 wt % and less than or equal to 16 wt %, greater than or equal to 5 wt % and less than or equal to 14 wt %, greater than or equal to 6 wt % and less than or equal to 14 wt %, greater than or equal to 7 wt % and less than or equal to 14 wt %, greater than or equal to 8 wt % and less than or equal to 14 wt %, greater than or equal to 9 wt % and less than or equal to 14 wt %, or even greater than or equal to 10 wt % and less than or equal to 14 wt %. It should be understood that the above ranges include all subranges within the explicitly disclosed ranges. In embodiments, the residual amorphous glass content can be 20, 19, 18, 17, 16, 15, 14, 13, 12, 11, or 10 wt %.

The precursor glasses and glass-ceramics described herein may be generally described as lithium-containing aluminosilicate precursor glasses and glass-ceramics and comprise SiO₂, Al₂O₃, P₂O₅, ZrO₂, CaO, Li₂O and copper (in the form of CuO, Cu₂O, and/or metallic copper). In addition, the precursor glasses and glass-ceramics embodied herein may further contain alkali oxides, such as Na₂O, K₂O, Rb₂O, or Cs₂O, as well as one or more other components as described herein. As noted herein, the major crystallite phases of the phase assemblage of the glass-ceramics described herein include petalite and lithium disilicate. This means that the amount petalite and lithium disilicate in the glass-ceramics are greater than any other crystalline phase present in the glass-ceramics. In embodiments, the glass-ceramics may comprise greater than 0 wt % and less than 10 wt %, less than 9 wt %, less than 8 wt %, less than 7 wt %, less than 6 wt %, less than 5 wt %, less than 4 wt %, or even less than 3 wt %, of the sum of other crystalline phases (such as, but not limited to lithium metasilicate (Li₂SiO₃), virgilite (LiₓAlₓSi₃₋ₓO₆), cristabolite (SiO₂), Quartz (SiO₂), zirconia (ZrO₂), baddeleyite (ZrO₂), spodumene (LiAlSi₂O₆), and lithium phosphate (Li₃PO₄)).

As noted herein, the glass-ceramics described herein include copper metal nanoparticles dispersed in the residual amorphous glass phase. The copper metal nanoparticles in the residual amorphous glass phase impart color to the glass-ceramics. In embodiments, a size distribution of the copper metal nanoparticles contained in the glass-ceramic is such that the peak position of the largest dimension of the copper metal nanoparticles is in the range from greater than or equal to 20 nm to less than or equal to 40 nm. In embodiments, the copper metal nanoparticles may be precipitated in the residual amorphous glass phase during ceramming of the precursor glass into glass-ceramic. For example, the copper metal nanoparticles may be precipitated in the residual amorphous glass phase due to the reduction of copper (I) (as opposed to copper (II)) in the precursor glass during ceramming, thereby imparting the desired red color to the glass-ceramic. The copper (I) ions are present in the precursor glass due to the inclusion of Cu₂O in the precursor glass. It is noted that the reduction of copper (II) in the precursor glass (such as when only CuO is included in the precursor glass) does not lead to the precipitation of copper metal nanoparticles in the residual amorphous glass phase or the desired red color. Instead, the presence of only copper (II) in the precursor glass results in a glass-ceramic that is blue in appearance.

SiO₂, an oxide involved in the formation of glass, can function to stabilize the network structure of precursor glasses and glass-ceramics. The concentration of SiO₂ should be sufficiently high to form the petalite crystalline phase when the precursor glass is heat treated to convert the precursor glass to a glass-ceramic. The amount of SiO₂ may be limited to control the melting temperature of the glass, as the melting temperature of pure SiO₂ or high-SiO₂ glasses is undesirably high. In embodiments, the precursor glasses and glass-ceramics comprise greater than or equal to 55 wt % and less than or equal to 80 wt % SiO₂, greater than or equal to 55 wt % and less than or equal to 75 wt % SiO₂, greater than or equal to 55 wt % and less than or equal to 73 wt % SiO₂, greater than or equal to 55 wt % and less than or equal to 72 wt % SiO₂, greater than or equal to 60 wt % and less than or equal to 80 wt % SiO₂, greater than or equal to 60 wt % and less than or equal to 75 wt % SiO₂, greater than or equal to 60 wt % and less than or equal to 73 wt % SiO₂, greater than or equal to 60 wt % and less than or equal to 72 wt % SiO₂, greater than or equal to 65 wt % and less than or equal to 80 wt % SiO₂, greater than or equal to 65 wt % and less than or equal to 75 wt % SiO₂, greater than or equal to 65 wt % and less than or equal to 73 wt % SiO₂, greater than or equal to 65 wt % and less than or equal to 72 wt % SiO₂, greater than or equal to 65 wt % and less than or equal to 80 wt % SiO₂, greater than or equal to 65 wt % and less than or equal to 79 wt % SiO₂, greater than or equal to 65 wt % and less than or equal to 78 wt % SiO₂, greater than or equal to 65 wt % and less than or equal to 77 wt % SiO₂, greater than or equal to 65 wt % and less than or equal to 76 wt % SiO₂, greater than or equal to 65 wt % and less than or equal to 75 wt % SiO₂, greater than or equal to 65 wt % and less than or equal to 74 wt % SiO₂, greater than or equal to 65 wt % and less than or equal to 73 wt % SiO₂, or even greater than or equal to 65 wt % and less than or equal to 72 wt % SiO₂. It should be understood that the above ranges include all subranges within the explicitly disclosed ranges.

Al₂O₃ may also provide stabilization to the network and provides improved mechanical properties and chemical durability. If the amount of Al₂O₃ is too high, however, the fraction of lithium disilicate crystals may be decreased, possibly to the extent that an interlocking structure cannot be formed. The amount of Al₂O₃ can be tailored to control the viscosity of the precursor glass during melting and forming. Further, if the amount of Al₂O₃ is too high, the viscosity of the melt is also generally increased. In embodiments, the precursor glasses and glass-ceramics comprise greater than or equal to 1 wt % and less than or equal to 15 wt % Al₂O₃, greater than or equal to 2 wt % and less than or equal to 15 wt % Al₂O₃, greater than or equal to 3 wt % and less than or equal to 15 wt % Al₂O₃, greater than or equal to 4 wt % and less than or equal to 15 wt % Al₂O₃, greater than or equal to 5 wt % and less than or equal to 15 wt % Al₂O₃, greater than or equal to 1 wt % and less than or equal to 12 wt % Al₂O₃, 2 wt % and less than or equal to 12 wt % Al₂O₃, greater than or equal to 3 wt % and less than or equal to 12 wt % Al₂O₃, greater than or equal to 4 wt % and less than or equal to 12 wt % Al₂O₃, greater than or equal to 5 wt % and less than or equal to 12 wt % Al₂O₃, 1 wt % and less than or equal to 10 wt % Al₂O₃, 2 wt % and less than or equal to 10 wt % Al₂O₃, greater than or equal to 3 wt % and less than or equal to 10 wt % Al₂O₃, greater than or equal to 4 wt % and less than or equal to 10 wt % Al₂O₃, greater than or equal to 5 wt % and less than or equal to 10 wt % Al₂O₃, 1 wt % and less than or equal to 8 wt % Al₂O₃, 2 wt % and less than or equal to 8 wt % Al₂O₃, greater than or equal to 3 wt % and less than or equal to 8 wt % Al₂O₃, greater than or equal to 4 wt % and less than or equal to 8 wt % Al₂O₃, greater than or equal to 5 wt % and less than or equal to 8 wt % Al₂O₃, 1 wt % and less than or equal to 6 wt % Al₂O₃, 2 wt % and less than or equal to 6 wt % Al₂O₃, greater than or equal to 3 wt % and less than or equal to 6 wt % Al₂O₃, or even greater than or equal to 4 wt % and less than or equal to 6 wt % Al₂O₃. It should be understood that the above ranges include all subranges within the explicitly disclosed ranges.

In the precursor glasses and glass-ceramics described herein, Li₂O aids in forming both petalite and lithium disilicate crystal phases. In fact, to obtain petalite and lithium disilicate as the predominant crystal phases, it is desirable to have at least about 7 wt % Li₂O in the composition. Additionally, it has been found that once Li₂O approaches about 17 wt %, the viscosity of the precursor glass may be reduced to an undesirable level. Accordingly, in embodiments, the precursor glasses and glass-ceramics can comprise greater than or equal to 7 wt % and less than or equal to 17 wt % Li₂O, 8 wt % and less than or equal to 17 wt % Li₂O, greater than or equal to 10 wt % and less than or equal to 17 wt % Li₂O, greater than or equal to 11 wt % and less than or equal to 17 wt % Li₂O, greater than or equal to 12 wt % and less than or equal to 17 wt % Li₂O, greater than or equal to 14 wt % and less than or equal to 17 wt % Li₂O, greater than or equal to 16 wt % and less than or equal to 17 wt % Li₂O, greater than or equal to 7 wt % and less than or equal to 16 wt % Li₂O, greater than or equal to 8 wt % and less than or equal to 16 wt % Li₂O, greater than or equal to 10 wt % and less than or equal to 16 wt % Li₂O, greater than or equal to 11 wt % and less than or equal to 16 wt % Li₂O, greater than or equal to 12 wt % and less than or equal to 16 wt % Li₂O, greater than or equal to 14 wt % and less than or equal to 16 wt % Li₂O, greater than or equal to 7 wt % and less than or equal to 15 wt % Li₂O, greater than or equal to 8 wt % and less than or equal to 15 wt % Li₂O, greater than or equal to 10 wt % and less than or equal to 15 wt % Li₂O, greater than or equal to 11 wt % and less than or equal to 15 wt % Li₂O, greater than or equal to 12 wt % and less than or equal to 15 wt % Li₂O, greater than or equal to 14 wt % and less than or equal to 15 wt % Li₂O, greater than or equal to 7 wt % and less than or equal to 14 wt % Li₂O, greater than or equal to 8 wt % and less than or equal to 14 wt % Li₂O, greater than or equal to 10 wt % and less than or equal to 14 wt % Li₂O, greater than or equal to 11 wt % and less than or equal to 14 wt % Li₂O, greater than or equal to 12 wt % and less than or equal to 14 wt % Li₂O, greater than or equal to 7 wt % and less than or equal to 13 wt % Li₂O, greater than or equal to 8 wt % and less than or equal to 13 wt % Li₂O, greater than or equal to 10 wt % and less than or equal to 13 wt % Li₂O, greater than or equal to 11 wt % and less than or equal to 13 wt % Li₂O, greater than or equal to 12 wt % and less than or equal to 13 wt % Li₂O, greater than or equal to 7 wt % and less than or equal to 12 wt % Li₂O, greater than or equal to 8 wt % and less than or equal to 12 wt % Li₂O, or even greater than or equal to 10 wt % and less than or equal to 12 wt % Li₂O. It should be understood that the above ranges include all subranges within the explicitly disclosed ranges.

As noted herein, the alkali metal oxide Li₂O is generally useful for forming various glass-ceramics. However, other alkali metal oxides tend to decrease glass-ceramic formation and, instead, form an aluminosilicate residual amorphous glass in the glass-ceramics. It has been found that more than about 5 wt % Na₂O or K₂O, or combinations thereof, leads to excessive amorphous residual glass, which can lead to deformation during crystallization and undesirable microstructures from a mechanical property perspective. The composition of the amorphous residual glass may be tailored to control viscosity during crystallization, minimizing deformation or undesirable thermal expansion, or control microstructure properties. Therefore, in general, the precursor glass may comprise relatively low amounts of non-lithium alkali metal oxides. For example, in embodiments, the precursor glass or glass-ceramic can comprise greater than or equal to 0 wt % to less than or equal to 5.5 wt % R₂O, wherein R is one or more of the alkali cations Na and K. In embodiments, the precursor glass or glass-ceramic composition can comprise from greater than or equal to 0 wt % to less than or equal to 3 wt % R₂O, wherein R is one or more of the alkali cations Na and K. In embodiments, the precursor glass or glass-ceramic composition can comprise from greater than or equal to 0.01 wt % to less than or equal to 0.5 wt % R₂O, greater than or equal to 0.01 wt % to less than or equal to 0.5 wt % R₂O, from greater than or equal to 0.01 wt % to less than or equal to 0.3 wt % R₂O, greater than or equal to 0.01 wt % to less than or equal to 0.25 wt % R₂O, greater than or equal to 0.1 wt % to less than or equal to 0.5 wt % R₂O, from greater than or equal to 0.1 wt % to less than or equal to 0.3 wt % R₂O, or even from greater than or equal to 0.1 wt % to less than or equal to 0.25 wt % R₂O, wherein R is one or more of the alkali cations Na and K. It should be understood that, in embodiments, the precursor glass and glass-ceramic does not comprise R₂O. In embodiments, the precursor glass and glass-ceramic are substantially free of R₂O, where R is one or more of the alkali cations Na and K.

In embodiments, the precursor glasses and glass-ceramics comprise greater than or equal to 0 wt % and less than or equal to 2.5 wt % Na₂O, greater than or equal to 0 wt % and less than or equal to 2 wt % Na₂O, greater than or equal to 0 wt % and less than or equal to 1 wt % Na₂O, or even greater than or equal to 0 wt % and less than or equal to 0.5 wt % Na₂O. It should be understood that the above ranges include all subranges within the explicitly disclosed ranges.

In embodiments, the precursor glasses and glass-ceramics comprise greater than or equal to 0 wt % and less than or equal to 3 wt % K₂O, greater than or equal to 0 wt % and less than or equal to 2 wt % K₂O, greater than or equal to 0 wt % and less than or equal to 1 wt % K₂O, greater than or equal to 0.01 wt % and less than or equal to 1 wt % K₂O, greater than or equal to 0.05 wt % and less than or equal to 1 wt % K₂O, greater than or equal to 0.1 wt % and less than or equal to 1 wt % K₂O, greater than or equal to 0 wt % and less than or equal to 0.5 wt % K₂O, greater than or equal to 0.01 wt % and less than or equal to 0.5 wt % K₂O, greater than or equal to 0.05 wt % and less than or equal to 0.5 wt % K₂O or even greater than or equal to 0.1 wt % and less than or equal to 0.5 wt % K₂O. It should be understood that the above ranges include all subranges within the explicitly disclosed ranges.

The precursor glasses and glass-ceramics include P₂O₅. P₂O₅ can function as a nucleating agent to produce bulk nucleation. If the concentration of P₂O₅ is too low, the precursor glass does crystallize, but only at higher temperatures (due to a lower viscosity) and from the surface inward, yielding a weak and often deformed body. However, if the concentration of P₂O₅ is too high, the devitrification, upon cooling during the formation of glass sheets, can be difficult to control. Embodiments of the precursor glasses and glass-ceramics comprise greater than or equal to 0.1 wt % and less than or equal to 5.0 wt % P₂O₅, greater than or equal to 0.5 wt % and less than or equal to 5.0 wt % P₂O₅, greater than or equal to 1.0 wt % and less than or equal to 5.0 wt % P₂O₅, greater than or equal to 1.5 wt % and less than or equal to 5.0 wt % P₂O₅, greater than or equal to 2.0 wt % and less than or equal to 5.0 wt % P₂O₅, greater than or equal to 2.25 wt % and less than or equal to 5.0 wt % P₂O₅, greater than or equal to 2.5 wt % and less than or equal to 5.0 wt % P₂O₅, greater than or equal to 3.0 wt % and less than or equal to 5.0 wt % P₂O₅, greater than or equal to 0.1 wt % and less than or equal to 4.5 wt % P₂O₅, greater than or equal to 0.5 wt % and less than or equal to 4.5 wt % P₂O₅, greater than or equal to 1.0 wt % and less than or equal to 4.5 wt % P₂O₅, greater than or equal to 1.5 wt % and less than or equal to 4.5 wt % P₂O₅, greater than or equal to 2.0 wt % and less than or equal to 4.5 wt % P₂O₅, greater than or equal to 2.25 wt % and less than or equal to 4.5 wt % P₂O₅, greater than or equal to 2.5 wt % and less than or equal to 4.5 wt % P₂O₅, greater than or equal to 3.0 wt % and less than or equal to 4.5 wt % P₂O₅, greater than or equal to 0.1 wt % and less than or equal to 4.0 wt % P₂O₅, greater than or equal to 0.5 wt % and less than or equal to 4.0 wt % P₂O₅, greater than or equal to 1.0 wt % and less than or equal to 4.0 wt % P₂O₅, greater than or equal to 1.5 wt % and less than or equal to 4.0 wt % P₂O₅, greater than or equal to 2.0 wt % and less than or equal to 4.0 wt % P₂O₅, greater than or equal to 2.25 wt % and less than or equal to 4.0 wt % P₂O₅, greater than or equal to 2.5 wt % and less than or equal to 4.0 wt % P₂O₅, greater than or equal to 3.0 wt % and less than or equal to 4.0 wt % P₂O₅, greater than or equal to 0.1 wt % and less than or equal to 3.5 wt % P₂O₅, greater than or equal to 0.5 wt % and less than or equal to 3.5 wt % P₂O₅, greater than or equal to 1.0 wt % and less than or equal to 3.5 wt % P₂O₅, greater than or equal to 1.5 wt % and less than or equal to 3.5 wt % P₂O₅, greater than or equal to 2.0 wt % and less than or equal to 3.5 wt % P₂O₅, greater than or equal to 2.25 wt % and less than or equal to 3.5 wt % P₂O₅, greater than or equal to 2.5 wt % and less than or equal to 3.5 wt % P₂O₅, greater than or equal to 3.0 wt % and less than or equal to 3.5 wt % P₂O₅, greater than or equal to 0.1 wt % and less than or equal to 3.0 wt % P₂O₅, greater than or equal to 0.5 wt % and less than or equal to 3.0 wt % P₂O₅, greater than or equal to 1.0 wt % and less than or equal to 3.0 wt % P₂O₅, greater than or equal to 1.5 wt % and less than or equal to 3.0 wt % P₂O₅, greater than or equal to 2.0 wt % and less than or equal to 3.0 wt % P₂O₅, greater than or equal to 2.25 wt % and less than or equal to 3.0 wt % P₂O₅, greater than or equal to 2.5 wt % and less than or equal to 3.0 wt % P₂O₅, greater than or equal to 0.1 wt % and less than or equal to 2.5 wt % P₂O₅, greater than or equal to 0.5 wt % and less than or equal to 2.5 wt % P₂O₅, greater than or equal to 1.0 wt % and less than or equal to 2.5 wt % P₂O₅, greater than or equal to 1.5 wt % and less than or equal to 2.5 wt % P₂O₅, greater than or equal to 2.0 wt % and less than or equal to 2.5 wt % P₂O₅, greater than or equal to 0.1 wt % and less than or equal to 2.0 wt % P₂O₅, greater than or equal to 0.5 wt % and less than or equal to 2.0 wt % P₂O₅, greater than or equal to 1.0 wt % and less than or equal to 2.0 wt % P₂O₅, greater than or equal to 1.5 wt % and less than or equal to 2.0 wt % P₂O₅, greater than or equal to 0.1 wt % and less than or equal to 1.5 wt % P₂O₅, greater than or equal to 0.5 wt % and less than or equal to 1.5 wt % P₂O₅, greater than or equal to 1.0 wt % and less than or equal to 1.5 wt % P₂O₅, greater than or equal to 0.1 wt % and less than or equal to 1.0 wt % P₂O₅, greater than or equal to 0.5 wt % and less than or equal to 1.0 wt % P₂O₅, or greater than or equal to 0.1 wt % and less than or equal to 0.5 wt % P₂O₅. It should be understood that the above ranges include all subranges within the explicitly disclosed ranges.

In addition to the other effects of ZrO₂ described herein, it is generally found that ZrO₂ can improve the stability of Li₂O—Al₂O₃—SiO₂—P₂O₅ glass by significantly reducing glass devitrification during forming and lowering the liquidus temperature. At concentrations above 8 wt %, ZrSiO₄ can form a primary liquidus phase at a high temperature, which significantly lowers liquidus viscosity. Transparent precursor glasses can be formed when the glass contains over 2 wt % ZrO₂. The addition of ZrO₂ can also help decrease the petalite grain size, which aids in the formation of a transparent glass-ceramic. In embodiments, the precursor glasses and glass-ceramics comprise greater than or equal to 2 wt % and less than or equal to 15 wt % ZrO₂, greater than or equal to 3 wt % and less than or equal to 15 wt % ZrO₂, greater than or equal to 4 wt % and less than or equal to 15 wt % ZrO₂, greater than or equal to 5 wt % and less than or equal to 15 wt % ZrO₂, greater than or equal to 2 wt % and less than or equal to 14 wt % ZrO₂, greater than or equal to 3 wt % and less than or equal to 14 wt % ZrO₂, greater than or equal to 4 wt % and less than or equal to 14 wt % ZrO₂, greater than or equal to 5 wt % and less than or equal to 14 wt % ZrO₂, greater than or equal to 2 wt % and less than or equal to 13 wt % ZrO₂, greater than or equal to 3 wt % and less than or equal to 13 wt % ZrO₂, greater than or equal to 4 wt % and less than or equal to 13 wt % ZrO₂, greater than or equal to 5 wt % and less than or equal to 13 wt % ZrO₂, greater than or equal to 2 wt % and less than or equal to 12 wt % ZrO₂, greater than or equal to 3 wt % and less than or equal to 12 wt % ZrO₂, greater than or equal to 4 wt % and less than or equal to 12 wt % ZrO₂, greater than or equal to 5 wt % and less than or equal to 12 wt % ZrO₂, greater than or equal to 2 wt % and less than or equal to 11 wt % ZrO₂, greater than or equal to 3 wt % and less than or equal to 11 wt % ZrO₂, greater than or equal to 4 wt % and less than or equal to 11 wt % ZrO₂, greater than or equal to 5 wt % and less than or equal to 11 wt % ZrO₂, greater than or equal to 2 wt % and less than or equal to 10 wt % ZrO₂, greater than or equal to 3 wt % and less than or equal to 10 wt % ZrO₂, greater than or equal to 4 wt % and less than or equal to 10 wt % ZrO₂, greater than or equal to 5 wt % and less than or equal to 10 wt % ZrO₂, greater than or equal to 2 wt % and less than or equal to 9 wt % ZrO₂, greater than or equal to 3 wt % and less than or equal to 9 wt % ZrO₂, greater than or equal to 4 wt % and less than or equal to 9 wt % ZrO₂, greater than or equal to 5 wt % and less than or equal to 9 wt % ZrO₂, greater than or equal to 2 wt % and less than or equal to 8 wt % ZrO₂, greater than or equal to 3 wt % and less than or equal to 8 wt % ZrO₂, greater than or equal to 4 wt % and less than or equal to 8 wt % ZrO₂, greater than or equal to 5 wt % and less than or equal to 8 wt % ZrO₂, greater than or equal to 2 wt % and less than or equal to 7 wt % ZrO₂, greater than or equal to 3 wt % and less than or equal to 7 wt % ZrO₂, greater than or equal to 4 wt % and less than or equal to 7 wt % ZrO₂, greater than or equal to 5 wt % and less than or equal to 7 wt % ZrO₂, greater than or equal to 2 wt % and less than or equal to 6 wt % ZrO₂, greater than or equal to 3 wt % and less than or equal to 6 wt % ZrO₂, greater than or equal to 4 wt % and less than or equal to 6 wt % ZrO₂, greater than or equal to 2 wt % and less than or equal to 5 wt % ZrO₂, or even greater than or equal to 3 wt % and less than or equal to 5 wt % ZrO₂, It should be understood that the above ranges include all subranges within the explicitly disclosed ranges.

In embodiments, the precursor glasses and glass-ceramics comprise greater than or equal to 0 wt % and less than or equal to 1.0 wt % SnO, greater than or equal to 0.01 wt % and less than or equal to 1.0 wt % SnO, greater than or equal to 0.1 wt % and less than or equal to 1.0 wt % SnO, greater than or equal to 0.01 wt % and less than or equal to 0.6 wt % SnO, or even greater than or equal to 0.1 wt % and less than or equal to 0.6 wt % SnO. It should be understood that the above ranges include all subranges within the explicitly disclosed ranges.

As noted, the glass-ceramics described herein may include copper metal nanoparticles dispersed in the residual amorphous glass phase of the glass-ceramic to achieve the desired red color in the glass-ceramic. The copper metal nanoparticles may be precipitated in the residual amorphous glass phase during ceramming of the precursor glass into glass-ceramic by, for example, the reduction of copper (I) (as opposed to copper (II)) in the precursor glass during ceramming, thereby imparting the desired red color to the glass-ceramic. The copper (I) ions are present in the precursor glass due to the inclusion of Cu₂O in the precursor glass. In embodiments, the precursor glasses and glass-ceramics comprise greater than or equal to 0 wt % and less than or equal to 2.0 wt % Cu₂O, greater than or equal to 0.01 wt % and less than or equal to 2.0 wt % Cu₂O, greater than or equal to 0.05 wt % and less than or equal to 2.0 wt % Cu₂O, greater than or equal to 0.1 wt % and less than or equal to 2.0 wt % Cu₂O, greater than or equal to 0.5 wt % and less than or equal to 2.0 wt % Cu₂O, greater than or equal to 1.0 wt % and less than or equal to 2.0 wt % Cu₂O, greater than or equal to 1.5 wt % and less than or equal to 2.0 wt % Cu₂O, greater than or equal to 0 wt % and less than or equal to 1.5 wt % Cu₂O, greater than or equal to 0.01 wt % and less than or equal to 1.5 wt % Cu₂O, greater than or equal to 0.1 wt % and less than or equal to 1.5 wt % Cu₂O, greater than or equal to 0.5 wt % and less than or equal to 1.5 wt % Cu₂O, greater than or equal to 1.0 wt % and less than or equal to 1.5 wt % Cu₂O, greater than or equal to 0 wt % and less than or equal to 1.2 wt % Cu₂O, greater than or equal to 0.01 wt % and less than or equal to 1.2 wt % Cu₂O, greater than or equal to 0.1 wt % and less than or equal to 1.2 wt % Cu₂O, greater than or equal to 0.5 wt % and less than or equal to 1.2 wt % Cu₂O, greater than or equal to 0 wt % and less than or equal to 1.0 wt % Cu₂O, greater than or equal to 0.01 wt % and less than or equal to 1.0 wt % Cu₂O, greater than or equal to 0.1 wt % and less than or equal to 1.0 wt % Cu₂O, greater than or equal to 0.5 wt % and less than or equal to 1.0 wt % Cu₂O, greater than or equal to 0.05 wt % and less than or equal to 0.5 wt % Cu₂O, or even greater than or equal to 0.1 wt % and less than or equal to 0.5 wt % Cu₂O. It should be understood that the above ranges include all subranges within the explicitly disclosed ranges.

As noted herein, copper (II) (such as from CuO) in the precursor glass and glass-ceramics may impart an undesirable blue color to the glass-ceramics if the copper (II) is not included in combination with copper (I) (such as from Cu₂O). Accordingly, when CuO is present in the precursor glass or glass-ceramics, it is included in combination with Cu₂O. In embodiments, the precursor glasses and glass-ceramics comprise greater than or equal to 0 wt % and less than or equal to 2.0 wt % CuO, greater than or equal to 0.01 wt % and less than or equal to 2.0 wt % CuO, greater than or equal to 0.05 wt % and less than or equal to 2.0 wt % CuO, greater than or equal to 0.1 wt % and less than or equal to 2.0 wt % CuO, greater than or equal to 0.5 wt % and less than or equal to 2.0 wt % CuO, greater than or equal to 1.0 wt % and less than or equal to 2.0 wt % CuO, greater than or equal to 1.5 wt % and less than or equal to 2.0 wt % CuO, greater than or equal to 0 wt % and less than or equal to 1.5 wt % CuO, greater than or equal to 0.01 wt % and less than or equal to 1.5 wt % CuO, greater than or equal to 0.1 wt % and less than or equal to 1.5 wt % CuO, greater than or equal to 0.5 wt % and less than or equal to 1.5 wt % CuO, greater than or equal to 1.0 wt % and less than or equal to 1.5 wt % CuO, greater than or equal to 0 wt % and less than or equal to 1.2 wt % CuO, greater than or equal to 0.01 wt % and less than or equal to 1.2 wt % CuO, greater than or equal to 0.1 wt % and less than or equal to 1.2 wt % CuO, greater than or equal to 0.5 wt % and less than or equal to 1.2 wt % CuO, greater than or equal to 0 wt % and less than or equal to 1.0 wt % CuO, greater than or equal to 0.01 wt % and less than or equal to 1.0 wt % CuO, greater than or equal to 0.1 wt % and less than or equal to 1.0 wt % CuO, greater than or equal to 0.5 wt % and less than or equal to 1.0 wt % CuO, greater than or equal to 0.05 wt % and less than or equal to 0.5 wt % CuO, or even greater than or equal to 0.1 wt % and less than or equal to 0.5 wt % CuO. In embodiments, the precursor glass and glass-ceramics are free of CuO. In embodiments, the precursor glass and glass-ceramics are substantially free of CuO. It should be understood that the above ranges include all subranges within the explicitly disclosed ranges.

CaO can enter petalite crystals in a partial solid solution. In embodiments, the precursor glasses and glass-ceramics comprise greater than or equal to 0 wt % and less than or equal to 2.0 wt % CaO, greater than or equal to 0.05 wt % and less than or equal to 2.0 wt % CaO, greater than or equal to 0.1 wt % and less than or equal to 2.0 wt % CaO, greater than or equal to 0.5 wt % and less than or equal to 2.0 wt % CaO, greater than or equal to 1.0 wt % and less than or equal to 2.0 wt % CaO, greater than or equal to 1.5 wt % and less than or equal to 2.0 wt % CaO, greater than or equal to 0.05 wt % and less than or equal to 1.5 wt % CaO, greater than or equal to 0.1 wt % and less than or equal to 1.5 wt % CaO, greater than or equal to 0.5 wt % and less than or equal to 1.5 wt % CaO, greater than or equal to 1.0 wt % and less than or equal to 1.5 wt % CaO, greater than or equal to 0.05 wt % and less than or equal to 1.0 wt % CaO, greater than or equal to 0.1 wt % and less than or equal to 1.0 wt % CaO, greater than or equal to 0.5 wt % and less than or equal to 1.0 wt % CaO, greater than or equal to 0.05 wt % and less than or equal to 0.5 wt % CaO, greater than or equal to 0.1 wt % and less than or equal to 0.5 wt % CaO, or greater than or equal to 0.01 wt % and less than or equal to 0.1 wt % CaO. It should be understood that the above ranges include all subranges within the explicitly disclosed ranges.

In embodiments, the precursor glasses or glass-ceramics may further include MgO. Without wishing to be bound by theory, it is believed that additions of MgO may enter the residual amorphous glass phase or the petalite crystalline phase. It is believed that additions of MgO that enter the residual amorphous glass phase may decrease the diffusivity of alkali ions in the glass, such as during ion exchange. As such, the content of MgO in the embodiments described herein is limited to 2.0 wt % to avoid any deleterious effects on ion exchange performance. In embodiments, the precursor glasses and glass-ceramics comprise greater than or equal to 0 wt % and less than or equal to 2.0 wt % MgO, greater than or equal to 0 wt % and less than or equal to 1.5 wt % MgO, greater than or equal to 0 wt % and less than or equal to 1.0 wt % MgO, greater than or equal to 0 wt % and less than or equal to 0.5 wt % MgO, greater than or equal to 0.1 wt % and less than or equal to 2.0 wt % MgO, greater than or equal to 0.1 wt % and less than or equal to 1.5 wt % MgO, greater than or equal to 0.1 wt % and less than or equal to 1.0 wt % MgO, or even greater than or equal to 0.1 wt % and less than or equal to 0.5 wt % MgO. In embodiments, the precursor glasses and glass-ceramics do not include MgO. In embodiments, the precursor glasses and glass-ceramics are substantially free of MgO. It should be understood that the above ranges include all subranges within the explicitly disclosed ranges.

In embodiments, the precursor glasses or glass-ceramics may further include SrO. Without wishing to be bound by theory, it is believed that SrO, when present, may increase the amount of residual glass in the resultant glass-ceramics. In embodiments, the precursor glasses and glass-ceramics comprise greater than or equal to 0 wt % and less than or equal to 2.0 wt % SrO, greater than or equal to 0 wt % and less than or equal to 1.5 wt % SrO, greater than or equal to 0 wt % and less than or equal to 1.0 wt % SrO, greater than or equal to 0 wt % and less than or equal to 0.5 wt % SrO, greater than or equal to 0.1 wt % and less than or equal to 2.0 wt % SrO, greater than or equal to 0.1 wt % and less than or equal to 1.5 wt % SrO, greater than or equal to 0.1 wt % and less than or equal to 1.0 wt % SrO, or even greater than or equal to 0.1 wt % and less than or equal to 0.5 wt % SrO. In embodiments, the precursor glasses and glass-ceramics do not include SrO. In embodiments, the precursor glasses and glass-ceramics are substantially free of SrO. It should be understood that the above ranges include all subranges within the explicitly disclosed ranges.

In embodiments, the precursor glasses or glass-ceramics may further include BaO. Without wishing to be bound by theory, it is believed that BaO, when present, may increase the amount of residual glass in the resultant glass-ceramics. In embodiments, the precursor glasses and glass-ceramics comprise greater than or equal to 0 wt % and less than or equal to 2.0 wt % BaO, greater than or equal to 0 wt % and less than or equal to 1.5 wt % BaO, greater than or equal to 0 wt % and less than or equal to 1.0 wt % BaO, greater than or equal to 0 wt % and less than or equal to 0.5 wt % BaO, greater than or equal to 0.1 wt % and less than or equal to 2.0 wt % BaO, greater than or equal to 0.1 wt % and less than or equal to 1.5 wt % BaO, greater than or equal to 0.1 wt % and less than or equal to 1.0 wt % BaO, or even greater than or equal to 0.1 wt % and less than or equal to 0.5 wt % BaO. In embodiments, the precursor glasses and glass-ceramics do not include BaO. In embodiments, the precursor glasses and glass-ceramics are substantially free of BaO. It should be understood that the above ranges include all subranges within the explicitly disclosed ranges.

In embodiments, the precursor glasses or glass-ceramics may further include ZnO. In embodiments, the precursor glasses and glass-ceramics comprise greater than or equal to 0 wt % and less than or equal to 4.0 wt % ZnO, greater than or equal to 0 wt % and less than or equal to 3.0 wt % ZnO, greater than or equal to 0 wt % and less than or equal to 2.5 wt % ZnO, greater than or equal to 0 wt % and less than or equal to 2.0 wt % ZnO, greater than or equal to 0 wt % and less than or equal to 1.5 wt % ZnO, greater than or equal to 0 wt % and less than or equal to 1.0 wt % ZnO, greater than or equal to 0 wt % and less than or equal to 0.5 wt % ZnO, greater than or equal to 0.1 wt % and less than or equal to 4.0 wt % ZnO, greater than or equal to 0.1 to less than or equal to 3 wt % ZnO, greater than or equal to 0.1 wt % and less than or equal to 2.5 wt % ZnO, greater than or equal to 0.1 wt % and less than or equal to 2.0 wt % ZnO, greater than or equal to 0.1 wt % and less than or equal to 1.5 wt % ZnO, greater than or equal to 0.1 wt % and less than or equal to 1.0 wt % ZnO, or even greater than or equal to 0.1 wt % and less than or equal to 0.5 wt % ZnO. In embodiments, the precursor glasses and glass-ceramics do not include ZnO. In embodiments, the precursor glasses and glass-ceramics are substantially free of ZnO. It should be understood that the above ranges include all subranges within the explicitly disclosed ranges.

In embodiments, the precursor glasses or glass-ceramics may further include B₂O₃. Without wishing to be bound by theory, it is believed that additions of B₂O₃ may partition into the amorphous residual glass. It is also believed that additions of B₂O₃ may lower the viscosity of the precursor glass at ceramming temperatures. In embodiments, the precursor glasses and glass-ceramics comprise greater than or equal to 0 wt % and less than or equal to 2.0 wt % B₂O₃, greater than or equal to 0 wt % and less than or equal to 1.5 wt % B₂O₃, greater than or equal to 0 wt % and less than or equal to 1.0 wt % B₂O₃, greater than or equal to 0 wt % and less than or equal to 0.5 wt % B₂O₃, greater than or equal to 0.1 wt % and less than or equal to 2.0 wt % B₂O₃, greater than or equal to 0.1 wt % and less than or equal to 1.5 wt % B₂O₃, greater than or equal to 0.1 wt % and less than or equal to 1.0 wt % B₂O₃, or even greater than or equal to 0.1 wt % and less than or equal to 0.5 wt % B₂O₃. In embodiments, the precursor glasses and glass-ceramics do not include B₂O₃. In embodiments, the precursor glasses and glass-ceramics are substantially free of B₂O₃. It should be understood that the above ranges include all subranges within the explicitly disclosed ranges.

Fe₂O₃ can lower the melting point of the precursor glasses and glass-ceramics. However, adding too much Fe₂O₃ can alter the color of the precursor glass and glass-ceramics. In embodiments, the precursor glasses and glass-ceramics do not comprise Fe₂O₃. In embodiments, the precursor glasses and glass-ceramics are substantially free of Fe₂O₃. In embodiments, the precursor glasses and glass-ceramics comprise greater than 0.0 wt % and less than or equal to 1.0 wt % Fe₂O₃, greater than or equal to 0 wt % and less than or equal to 0.5 wt % Fe₂O₃, greater than 0.0 wt % and less than or equal to 0.3 wt % Fe₂O₃, greater than or equal to 0.0 wt % and less than or equal to 0.2 wt % Fe₂O₃, or greater than 0.0 wt % and less than or equal to 0.1 wt % Fe₂O₃. It should be understood that the above ranges include all subranges within the explicitly disclosed ranges.

In embodiments, the precursor glasses or glass-ceramics may further include HfO₂. Without wishing to be bound by theory, it is believed that additions of HfO₂ may at least partially replace ZrO₂ in the compositions. In embodiments, the precursor glasses and glass-ceramics comprise greater than or equal to 0 wt % and less than or equal to 3.0 wt % HfO₂, greater than or equal to 0 wt % and less than or equal to 2.5 wt % HfO₂, greater than or equal to 0 wt % and less than or equal to 2.0 wt % HfO₂, greater than or equal to 0 wt % and less than or equal to 1.5 wt % HfO₂, greater than or equal to 0 wt % and less than or equal to 1.0 wt % HfO₂, greater than or equal to 0 wt % and less than or equal to 0.5 wt % HfO₂, greater than or equal to 0 wt % and less than or equal to 0.2 wt % HfO₂, greater than or equal to 0.1 to less than or equal to 3 wt % HfO₂, greater than or equal to 0.1 wt % and less than or equal to 2.5 wt % HfO₂, greater than or equal to 0.1 wt % and less than or equal to 2.0 wt % HfO₂, greater than or equal to 0.1 wt % and less than or equal to 1.5 wt % HfO₂, greater than or equal to 0.1 wt % and less than or equal to 1.0 wt % HfO₂, greater than or equal to 0.1 wt % and less than or equal to 0.5 wt % HfO₂, or even greater than or equal to 0.1 wt % and less than or equal to 0.2 wt % HfO₂. In embodiments, the precursor glasses and glass-ceramics do not include HfO₂. In embodiments, the precursor glasses and glass-ceramics are substantially free of HfO₂. It should be understood that the above ranges include all subranges within the explicitly disclosed ranges.

In embodiments, the precursor glass or glass-ceramic may further include a chemical fining agent. Such fining agents include, but are not limited to, SnO₂, As₂O₃, Sb₂O₃, SO₃, F, Cl and Br. In some embodiments, the concentrations of the chemical fining agents are kept at a level of 3, 2, 1, or 0.5, >0 wt %. In embodiments, the chemical fining agent is SnO₂ and the precursor glass or glass-ceramic comprises greater than or equal to 0 to less than or equal to 3 wt % SnO₂. In embodiments, the precursor glass or glass-ceramic comprises greater than or equal to 0 wt % and less than or equal to 2.5 wt % SnO₂, greater than or equal to 0 wt % and less than or equal to 2.0 wt % SnO₂, greater than or equal to 0 wt % and less than or equal to 1.5 wt % SnO₂, greater than or equal to 0 wt % and less than or equal to 1.0 wt % SnO₂, greater than or equal to 0 wt % and less than or equal to 0.5 wt % SnO₂, greater than 0.01 wt % to less than or equal to 3 wt % SnO₂, greater than 0.01 wt % and less than or equal to 2.5 wt % SnO₂, greater than 0.01 wt % and less than or equal to 2.0 wt % SnO₂, greater than 0.01 wt % and less than or equal to 1.5 wt % SnO₂, greater than 0.01 wt % and less than or equal to 1.0 wt % SnO₂, or even greater than 0.01 wt % and less than or equal to 0.5 wt % SnO₂. It should be understood that the above ranges include all subranges within the explicitly disclosed ranges. In embodiments, the chemical fining agent may also include CeO₂, Fe₂O₃, and other oxides of transition metals, such as MnO₂. These oxides may introduce unwanted color to the precursor glass or glass-ceramic via visible absorptions in their final valence state(s) in the glass, and thus, when present, their concentration is usually kept at a level of 0.5, 0.4, 0.3, 0.2, 0.1 or >0 wt %. In embodiments, the precursor glass or glass-ceramic does not include a chemical fining agent.

In embodiments, the chemical fining agent is SO₃. In such embodiments, the SO₃ fining agent may be introduced in the precursor glass by including one or more sulfates (i.e., a “sulfate fining agent”) in the glass batch materials prior to or during melting. Suitable sulfates may include, without limitation, H₂SO₄, Li₂SO₄, Na₂SO₄, K₂SO₄, Cs₂SO₄, Zn₂SO₄, Mg₂SO₄, Ca₂SO₄, Sr₂SO₄, BazSO₄, Al₂(SO₄)₃, Ti(SO₄)₂, Si(SO₄)₂, Zr(SO₄)₂, B₂(SO₄)₃, Sn(SO₄)₂, and various combinations thereof. The amount of the sulfate fining agent added to the glass batch materials may be less than or equal to 0.5 wt %. If the amount of the sulfate fining agent exceeds 0.5 wt %, an undesirable energetic release of gaseous biproducts may occur during the thermal decomposition of the sulfate fining agent in the glass melt. In embodiments, the amount of the sulfate fining agent added to the glass batch materials may be less than or equal to 0.5 wt %, less than or equal to 0.45 wt %, less than or equal to 0.4 wt %, less than or equal to 0.35 wt %, less than or equal to 0.3 wt %, less than or equal to 0.25 wt %, less than or equal to 0.2 wt %, less than or equal to 0.15 wt %, less than or equal to 0.1 wt %, or even less than or equal to 0.05 wt %. In embodiments where a sulfate fining agent is included in the glass batch materials, the amount of the sulfate fining agent may be greater than or equal to 0.01 wt. %, greater than or equal to 0.02 wt. %, greater than or equal to 0.03 wt. %, greater than or equal to 0.04 wt. %, or even greater than or equal to 0.05 wt. %. In embodiments, the amount of sulfate fining agent added to the glass batch materials may be less than or equal to 0.5 wt % and greater than or equal to 0.01 wt. %, less than or equal to 0.5 wt % and greater than or equal to 0.02 wt. %, less than or equal to 0.5 wt % and greater than or equal to 0.03 wt. %, less than or equal to 0.5 wt % and greater than or equal to 0.04 wt. %, less than or equal to 0.5 wt % and greater than or equal to 0.05 wt. %, less than or equal to 0.45 wt % and greater than or equal to 0.01 wt. %, less than or equal to 0.45 wt % and greater than or equal to 0.02 wt. %, less than or equal to 0.45 wt % and greater than or equal to 0.03 wt. %, less than or equal to 0.45 wt % and greater than or equal to 0.04 wt. %, less than or equal to 0.45 wt % and greater than or equal to 0.05 wt. %, less than or equal to 0.4 wt % and greater than or equal to 0.01 wt. %, less than or equal to 0.4 wt % and greater than or equal to 0.02 wt. %, less than or equal to 0.4 wt % and greater than or equal to 0.03 wt. %, less than or equal to 0.4 wt % and greater than or equal to 0.04 wt. %, less than or equal to 0.4 wt % and greater than or equal to 0.05 wt. %, less than or equal to 0.35 wt % and greater than or equal to 0.01 wt. %, less than or equal to 0.35 wt % and greater than or equal to 0.02 wt. %, less than or equal to 0.35 wt % and greater than or equal to 0.03 wt. %, less than or equal to 0.35 wt % and greater than or equal to 0.04 wt. %, less than or equal to 0.35 wt % and greater than or equal to 0.05 wt. %, less than or equal to 0.3 wt % and greater than or equal to 0.01 wt. %, less than or equal to 0.3 wt % and greater than or equal to 0.02 wt. %, less than or equal to 0.3 wt % and greater than or equal to 0.03 wt. %, less than or equal to 0.3 wt % and greater than or equal to 0.04 wt. %, less than or equal to 0.3 wt % and greater than or equal to 0.05 wt. %, less than or equal to 0.25 wt % and greater than or equal to 0.01 wt. %, less than or equal to 0.25 wt % and greater than or equal to 0.02 wt. %, less than or equal to 0.25 wt % and greater than or equal to 0.03 wt. %, less than or equal to 0.25 wt % and greater than or equal to 0.04 wt. %, less than or equal to 0.25 wt % and greater than or equal to 0.05 wt. %, less than or equal to 0.2 wt % and greater than or equal to 0.01 wt. %, less than or equal to 0.2 wt % and greater than or equal to 0.02 wt. %, less than or equal to 0.2 wt % and greater than or equal to 0.03 wt. %, less than or equal to 0.2 wt % and greater than or equal to 0.04 wt. %, less than or equal to 0.2 wt % and greater than or equal to 0.05 wt. %, less than or equal to 0.15 wt % and greater than or equal to 0.01 wt. %, less than or equal to 0.15 wt % and greater than or equal to 0.02 wt. %, less than or equal to 0.15 wt % and greater than or equal to 0.03 wt. %, less than or equal to 0.15 wt % and greater than or equal to 0.04 wt. %, less than or equal to 0.15 wt % and greater than or equal to 0.05 wt. %, less than or equal to 0.1 wt % and greater than or equal to 0.01 wt. %, less than or equal to 0.1 wt % and greater than or equal to 0.02 wt. %, less than or equal to 0.1 wt % and greater than or equal to 0.03 wt. %, less than or equal to 0.1 wt % and greater than or equal to 0.04 wt. %, or even less than or equal to 0.1 wt % and greater than or equal to 0.05 wt. %. It should be understood that the above ranges include all subranges within the explicitly disclosed ranges.

As noted herein, the sulfate fining agents will thermally decompose in the glass melt. The biproducts of the thermal decomposition of the sulfate fining agents include gaseous biproducts, such as oxygen and sulfur dioxide, the release of which aid in fining the glass melt and removing other gases, such as oxygen for example, entrained in the glass melt. In embodiments, following thermal decomposition of the sulfate fining agents, sulfite (SO₃) may be present in the resulting precursor glass formed from the glass melt. In some embodiments, the thermal decomposition of the sulfate fining agents results in at least the partial removal of sulfur compounds from the glass melt. In some embodiments, the thermal decomposition of the sulfate fining agent may result in the complete removal of sulfur compounds from the glass melt. In embodiments, after the glass melt is fined with the sulfate fining agent and formed into a precursor glass, the amount of SO₃ in the precursor glass may be less than or equal to less than or equal to 0.4 wt %, less than or equal to 0.36 wt %, less than or equal to 0.32 wt %, less than or equal to 0.28 wt %, less than or equal to 0.24 wt %, less than or equal to 0.2 wt %, less than or equal to 0.16 wt %, less than or equal to 0.12 wt %, less than or equal to 0.08 wt %, or even less than or equal to 0.04 wt %. In embodiments, after the glass melt is fined with the sulfate fining agent and formed into a precursor glass, the amount of SO₃ in the precursor glass may be a detectable or measurable amount of sulfur (represented by SO₃ in the composition), such as greater than 0 wt % (e.g., greater than 10×10⁻⁶ wt %) and less than or equal to 0.4 wt %, greater than or equal to 0 wt % and less than or equal to 0.36 wt %, greater than or equal to 0 wt % and less than or equal to 0.32 wt %, greater than or equal to 0 wt % and less than or equal to 0.28 wt %, greater than or equal to 0 wt % and less than or equal to 0.24 wt %, greater than or equal to 0 wt % and less than or equal to 0.2 wt %, greater than or equal to 0 wt % and less than or equal to 0.16 wt %, greater than or equal to 0 wt % and less than or equal to 0.12 wt %, greater than or equal to 0 wt % and less than or equal to 0.08 wt %, or even greater than or equal to 0 wt % and less than or equal to 0.04 wt %. In embodiments, after the glass melt is fined with the sulfate fining agent and formed into a precursor glass, the amount of SO₃ in the precursor glass may be greater than or equal to 0.001 wt % and less than or equal to less than or equal to 0.4 wt %, greater than or equal to 0.001 wt % and less than or equal to 0.36 wt %, greater than or equal to 0.001 wt % and less than or equal to 0.32 wt %, greater than or equal to 0.001 wt % and less than or equal to 0.28 wt %, greater than or equal to 0.001 wt % and less than or equal to 0.24 wt %, greater than or equal to 0.001 and less than or equal to 0.2 wt %, greater than or equal to 0.001 wt % and less than or equal to 0.16 wt %, greater than or equal to 0.001 and less than or equal to 0.12 wt %, greater than or equal to 0.001 wt % and less than or equal to 0.08 wt %, or even greater than or equal to 0.001 and less than or equal to 0.04 wt %. It should be understood that the above ranges include all subranges within the explicitly disclosed ranges. That said, in embodiments, SO₃ may be used for fining as disclosed herein but leave no detectable or measurable trace in resulting glass fined thereby, such as the precursor glass, where the amount of SO₃ is 0 wt %.

It has now been determined that relatively small amounts of sulfate fining agents added to glass batch materials can be highly effective at fining the glass melt and reducing the occurrence of blister defects in the resulting glass. Moreover, sulfate fining agents have relatively low melting points and may also assist in more easily melting the glass batch materials, reducing the energy needed for melting the glass and reducing the overall temperature of the melter. Lower melting temperatures may, in turn, extend the service life of the melter, thereby decreasing glass manufacturing costs. The use of sulfate fining agents may also enable lower fining temperatures, extending the service life of the finer and further decreasing manufacturing costs. In addition, sulfate fining agents may be less expense than other batched fining agents (e.g., tin), and thus may further decrease the manufacturing costs of the glass.

Moreover, sulfate fining agents may also assist in maintaining a reducing environment in the glass manufacturing system which, in turn, may aid in maintaining copper ions in an oxidation state favorable for achieving the desired color, thereby improving color uniformity in the resulting glass. While sulfate fining agents may be beneficially used with the precursor glasses and glass-ceramics described herein, it should be understood that sulfate fining agents may also be used in glass compositions that do not containing colorants, such as in precursor glasses and glass ceramics that are transparent and free or substantially free of colorants.

In some embodiments, the precursor glass or glass-ceramic can be substantially free of Sb₂O₃, As₂O₃, or combinations thereof. For example, the precursor glass or glass-ceramic can comprise 0.05 weight percent or less of Sb₂O₃ or As₂O₃ or a combination thereof, the precursor glass or glass-ceramic may comprise 0 wt % of Sb₂O₃ or As₂O₃ or a combination thereof, or the precursor glass or glass-ceramic may be, for example, free of any intentionally added Sb₂O₃, As₂O₃, or combinations thereof.

In the embodiments disclosed herein, the precursor glasses may be formulated to have a certain optical basicity, which, in turn, aids in achieving the desired red color in the glass ceramics. In particular, it has been found that the red color of the glass-ceramics described herein is achieved by precipitating and growing copper metal nanoparticles in the residual amorphous glass phase of the glass-ceramic during the ceramming process (described in further detail herein). The copper metal nanoparticles precipitate in the residual amorphous glass phase from copper (I) ions in the precursor glass as the copper (I) ions are reduced to metallic copper during ceramming. However, copper metal nanoparticles are not as readily precipitated (if at all) from copper (II) ions in the precursor glass. Accordingly, the copper (I) ions in the precursor glass should be maintained in a +1 oxidation state such that copper metal nanoparticles can be precipitated in the glass-ceramic during ceramming and the desired red color can be achieved.

The optical basicity of a glass (such as the precursor glass) generally relates to the redox power of the glass. In the embodiments described herein, it has been found that maintaining the optical basicity of the precursor glass in the range from greater than or equal to about 0.45 and less than or equal to 0.60 provides for a glass-ceramic with vibrant red colors (i.e., glass-ceramics with relatively high a* values) upon ceramming. In embodiments, the optical basicity of the precursor glass may be in the range from greater than or equal to 0.47 to less than or equal to 0.49. Without wishing to be bound by theory, it is believed that optical basicity values within this range generally prevent the oxidation of copper (I) ions in the precursor glass such that the copper (I) ions may be reduced during ceramming and precipitated into the glass-ceramic as copper metal nanoparticles, thereby resulting in the desired red color.

The optical basicity of a glass can be described by the equation:

$${Λ}_{glass} = \frac{{\sum }_{i}^{N} {Λ}_{i} {n}_{i} {Z}_{i} {x}_{i}}{{Z}_{0} {\sum }_{i}^{N} {n}_{0} {y}_{i}} \qquad ( Equation 1 )$$

where xᵢ is the atom count of non-oxygen element i in the oxide; yᵢ is the atom count of oxygen element i in the oxide; Zᵢ is the valence of the element i in the oxide; Λᵢ is the basicity of the element i; n₀ is the atom count of the oxygen in the oxide; and Z₀ is the charge of the oxygen (nominally 2). Table A below shows the optical basicity for oxides that may be included in glass compositions.

TABLE A*

| Elements | Valence | Oxides | Basicity(A) |
|---|---|---|---|
| Al | 3+ | Al₂O₃ | 1.65⁻¹ |
| As | 3+ | As₂O₃ | 1 |
| B | 3+ | B₂O₃ | 2.36⁻¹ |
| Ba | 2+ | BaO | 1.15 |
| Bi | 3+ | Bi₂O₃ | 1.19 |
| C | 4+ | CO₂ | 3⁻¹ |
| Ca | 2+ | CaO | 1.0 |
| Cl | 3+ | — | 3.73⁻¹ |
| Cu | 1 | Cu₂O | 1 |
| Fe | 3+ | Fe₂O₃ | 0.785 |
| K | 1+ | K₂O | 0.73⁻¹ |
| Li | 1+ | Li₂O | 1.0 |
| Mg | 2+ | MgO | 1.28⁻¹ |
| Na | 1+ | Na₂O | 0.87⁻¹ |
| P | 5+ | P₂O₅ | 2.5⁻¹ |
| Si | 4+ | SiO₂ | 2.09⁻¹ |
| Sn | 2+ | SnO | 1.1 |
| Zn | 2+ | ZnO | 1.82⁻¹ |

*From “Optical Basicity and Nepheline Crystallization in High Alumina Glass,” C. P. Rodriguez, J. S. McCloy, M. J. Schweiger, J. V. Crum, and A. Winschell, Document # PNNL-20184 EMSP-RPT-003 (2011).

In embodiments, precursor glasses and glass-ceramics having the compositions described herein may be initially formed by mixing a batch of constituent component sources (i.e., SiO₂ sources, Al₂O₃ sources, and the like), heating the batch to form molten glass, and, thereafter, forming or shaping the molten glass into a glass article using conventional forming processes, such as slot draw, float, rolling, fusion forming, or the like. At this point, the glass or glass article may be referred to as a “precursor glass” which refers to the glass or glass article prior to ceramming to convert the glass to a glass-ceramic, thereby forming a glass-ceramic article.

In the embodiments described herein, the process of heating the batch to form molten glass may be controlled (in addition to the optical basicity) to preserve the oxidation state of copper (I) ions in the glass. As noted herein, it has been found that the red color of the glass-ceramics described herein is achieved by precipitating and growing copper metal nanoparticles in the residual amorphous glass phase of the glass-ceramic during the ceramming process (described in further detail herein). The copper metal nanoparticles precipitate in the residual amorphous glass phase from copper (I) ions in the precursor glass as the copper (I) ions are reduced to metallic copper. However, copper metal nanoparticles are not as readily precipitated (if at all) from copper (II) ions in the precursor glass. Accordingly, to preserve the oxidation state of copper (I) ions in the precursor glass, the atmospheric conditions adjacent to the molten glass during melting may be controlled to reduce the amount of oxygen present and, in turn, prevent the oxidation of copper (I) in the molten glass to copper (II).

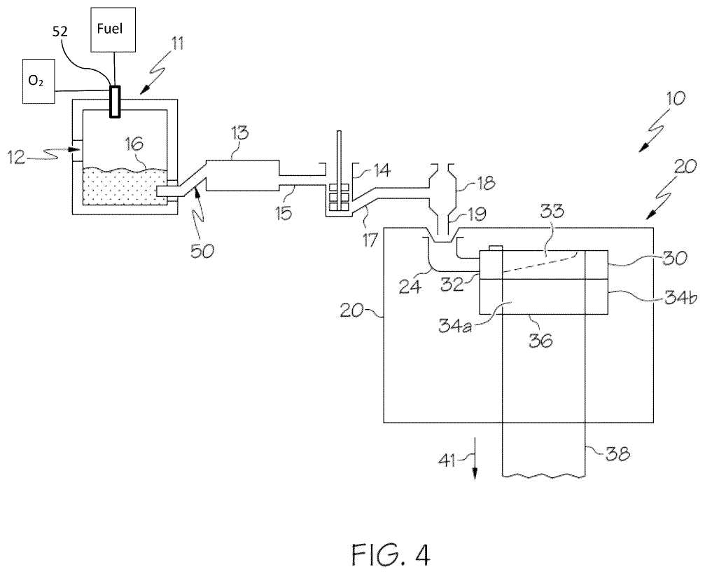

Referring to FIG. 4 by way of example, an embodiment of a glass manufacturing apparatus 10 for forming glass articles from molten glass is schematically depicted. The glass manufacturing apparatus 10 may include a melter 11, a fining system 13, a mixing vessel 14, a delivery vessel 18, and a forming apparatus 20. Glass batch materials are introduced into the melter 11 through a batch inlet port 12. The batch materials are melted in the melter 11 to form molten glass 16. The melter 11 is fluidly coupled to the fining system 13 with a connecting tube 50. The molten glass 16 flows from the melter 11, through the connecting tube 50, and into the fining system 13.

The fining system 13 may comprise a high temperature processing area that receives the molten glass 16 from the melter 11. While the molten glass 16 is resident in the fining system 13, dissolved gasses and/or bubbles are removed from the molten glass 16. The fining system 13 may be fluidly coupled to the mixing vessel 14 by a connecting tube 15. That is, molten glass flowing from the fining system 13 to the mixing vessel 14 may flow through the connecting tube 15. As the molten glass 16 passes through the mixing vessel 14, the molten glass 16 may be stirred to homogenize the molten glass. The mixing vessel 14 may be, in turn, fluidly coupled to the delivery vessel 18 by a connecting tube 17 such that molten glass flowing from the mixing vessel 14 to the delivery vessel 18 flows through the connecting tube 17.

The delivery vessel 18 supplies the molten glass 16 through a downcomer 19 into the forming apparatus 20. The forming apparatus 20 may be, for example and without limitation, a fusion draw machine or another forming apparatus for forming molten glass into a glass article such as ribbons, tubes, boules, or the like. In the embodiment depicted in FIG. 4 the forming apparatus 20 is a fusion draw machine that comprises an enclosure 22 in which an inlet 24 and a forming vessel 30 are positioned. The molten glass 16 from the downcomer 19 flows into the inlet 24, which leads to the forming vessel 30. The forming vessel 30 includes an opening 32 that receives the molten glass 16. The molten glass 16 may flow into a trough 33 and then overflows and runs down two converging sides 34a and 34b of the forming vessel 30 before fusing together at a root 36 of the forming vessel 30, where the two sides join, before being contacted and drawn in a downstream direction 41 to form a continuous glass ribbon 38 from which discrete sheets of glass may be segmented for further processing.

While FIG. 4 schematically depicts a glass manufacturing apparatus 10 for forming glass ribbon using a fusion draw machine, other processes may be used to form the glass ribbon, including, without limitation, roll-forming processes, float glass processes, slot draw processes and the like. Further, while the glass manufacturing apparatus 10 is depicted as being used for forming glass ribbon, other glass manufacturing apparatuses may be used for forming glass stock material other than glass sheets including, without limitation, glass tubes, glass cylinders, boules, and the like.

In the melter 11, batch materials are melted to form molten glass 16 with a combination of electrical heating, where electrodes are used to direct electrical current through the batch, and combustion heating, where fuel and oxygen are supplied to one or more burners 52 and combusted to heat the melter 11, including the atmosphere in the melter 11 in contact with the molten glass 16. As noted herein, during melting, excess oxygen in the melter 11 may cause the copper (I) in the molten glass 16 to oxidize to copper (II). The copper (II) remains in the molten glass 16 and, thereafter, the precursor glass (such as the continuous glass ribbon 38) discharged from the forming apparatus 20. Also as noted herein, during ceramming of the precursor glass, the copper (II) may not be readily reduced to precipitate copper metal nanoparticles. As a result, the desired red color in the resulting glass-ceramic may not be achieved,

In the embodiments described herein, the atmosphere in the melter 11 is controlled to limit the excess oxygen present and thereby mitigate the oxidation of copper (I) in the molten glass 16 to copper (II). In particular, the ratio of oxygen to fuel (i.e., oxygen:fuel) supplied to the burner 52 is reduced to limit the excess oxygen present in the melter 11 and thereby mitigate the oxidation of copper (I) to copper (II). In particular, the ratio of oxygen:fuel supplied to the burner 52 is less than 2.7:1 and greater than or equal to 1.8:1. In embodiments, the ratio of oxygen:fuel supplied to the burner 52 is less than or equal to 2.6:1 and greater than or equal to 1.8:1, less than or equal to 2.5:1 and greater than or equal to 1.8:1, less than or equal to 2.4:1 and greater than or equal to 1.8:1, less than or equal to 2.3:1 and greater than or equal to 1.8:1, less than or equal to 2.2:1 and greater than or equal to 1.8:1, less than or equal to 2.1:1 and greater than or equal to 1.8:1, or even less than or equal to 2.05:1 and greater than or equal to 1.8:1. Ratios of oxygen:fuel within this range mitigate the oxidation of copper (I) to copper (II) in the molten glass 16 such that copper (I) is present in the precursor glass discharged from the forming apparatus 20. Thereafter, during ceramming, the copper (I) in the precursor glass is reduced to copper metal particles that precipitate in the glass-ceramic, resulting in the desired red color of the glass-ceramic.

In the embodiments described herein, the term “fuel” refers to natural gas supplied to the burner 52. In embodiments, the natural glass includes 90% to 98% methane with the balance comprising ethane, propane, butane, carbon dioxide, nitrogen and water vapor. As one example, the natural gas may comprise 97.27% methane, 2.25% ethane, 0.10% propane, 0.12% carbon dioxide, and 0.24% nitrogen.

The processes for making glass-ceramics according to embodiments includes heat treating the precursor glass at two preselected temperatures for one or more preselected times to induce glass homogenization and crystallization (i.e., nucleation and growth) of one or more crystalline phases (e.g., having one or more compositions, amounts, morphologies, sizes or size distributions, etc.). These two temperatures may be referred to as the nucleation temperature and the growth temperature, respectively.

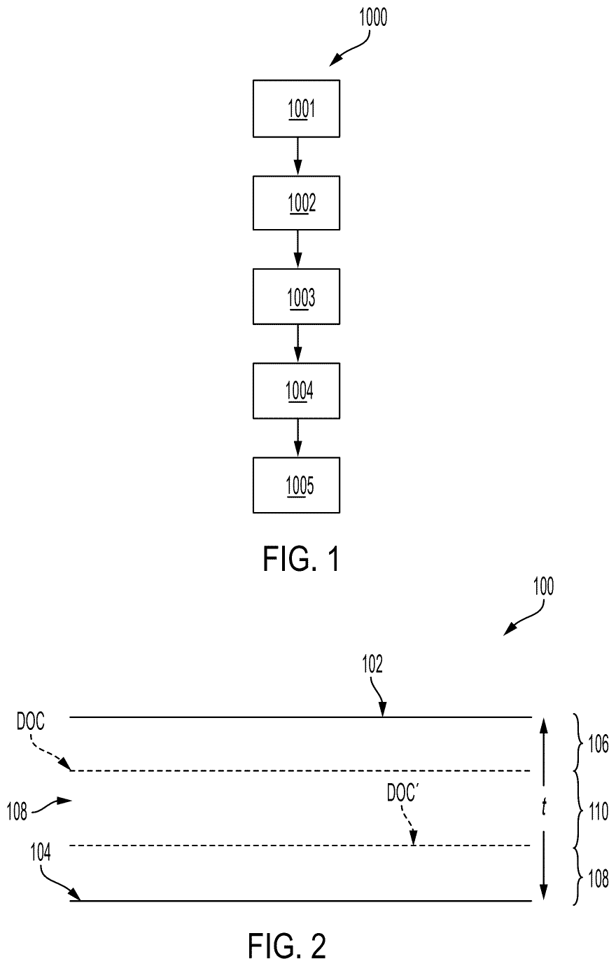

With reference now to FIG. 1, embodiments of methods 1000 for making glass-ceramics will generally be described. Initially, at step 1001, a precursor glass is heated in an oven to a nucleation temperature that is greater than or equal to 550° C. and less than 650° C. It should be understood that the nucleation temperature corresponds to the temperature of the oven in which the precursor glass is heated and that the temperature of the precursor glass may be within +/−5° C. of the nucleation temperature when the temperature of the oven is at the nucleation temperature. At step 1002, the precursor glass is held in the oven for a first duration in a temperature range that is greater than or equal to the nucleation temperature and less than 650° C. to form a nucleated precursor glass. In the embodiments described herein, the nucleated precursor glass comprises nuclei of the petalite crystalline phase, the lithium disilicate crystalline phase, and the copper metal nanoparticles. At step 1003, the nucleated precursor glass is heated to a growth temperature that is greater than or equal to 650° C. and less than or equal to 800° C. At step 1004, the nucleated precursor glass is held for a second duration in a temperature range that is greater than or equal to the growth temperature and less than or equal to 800° C. to form the glass-ceramic. In this phase, the nuclei of the petalite crystalline phase, the lithium disilicate crystalline phase, and the copper metal nanoparticles grow into the petalite crystalline phase, the lithium disilicate crystalline phase, and the copper metal nanoparticles. In embodiments, at step 1005, the glass-ceramic may be exposed to an ion exchange medium comprising a molten potassium salt, a molten sodium salt, or combinations thereof, with or without additions of LiNO₃ to the ion exchange bath, to form a strengthened glass-ceramic. Each of these steps will be described in more detail below.

In embodiments, the nucleation stage takes place when a precursor glass is held at the predetermined nucleation temperature for a predetermined duration. In embodiments, the nucleation temperature is greater than or equal to 550° C. and less than 650° C., greater than or equal to 560° C. and less than 650° C., greater than or equal to 570° C. and less than 650° C., greater than or equal to 580° C. and less than 650° C., greater than or equal to 590° C. and less than 650° C., greater than or equal to 600° C. and less than 650° C., greater than or equal to 610° C. and less than 650° C., greater than or equal to 620° C. and less than 650° C., greater than or equal to 630° C. and less than 650° C., greater than or equal to 640° C. and less than 650° C., greater than or equal to 550° C. and less than or equal to 640° C., greater than or equal to 560° C. and less than or equal to 640° C., greater than or equal to 570° C. and less than or equal to 640° C., greater than or equal to 580° C. and less than or equal to 640° C., greater than or equal to 590° C. and less than or equal to 640° C., greater than or equal to 600° C. and less than or equal to 640° C., greater than or equal to 610° C. and less than or equal to 640° C., greater than or equal to 620° C. and less than or equal to 640° C., greater than or equal to 630° C. and less than or equal to 640° C., greater than or equal to 550° C. and less than or equal to 630° C., greater than or equal to 560° C. and less than or equal to 630° C., greater than or equal to 570° C. and less than or equal to 630° C., greater than or equal to 580° C. and less than or equal to 630° C., greater than or equal to 590° C. and less than or equal to 630° C., greater than or equal to 600° C. and less than or equal to 630° C., greater than or equal to 610° C. and less than or equal to 630° C., greater than or equal to 620° C. and less than or equal to 630° C., greater than or equal to 550° C. and less than or equal to 620° C., greater than or equal to 560° C. and less than or equal to 620° C., greater than or equal to 570° C. and less than or equal to 620° C., greater than or equal to 580° C. and less than or equal to 620° C., greater than or equal to 590° C. and less than or equal to 620° C., greater than or equal to 600° C. and less than or equal to 620° C., greater than or equal to 610° C. and less than or equal to 620° C., greater than or equal to 550° C. and less than or equal to 610° C., greater than or equal to 560° C. and less than or equal to 610° C., greater than or equal to 570° C. and less than or equal to 610° C., greater than or equal to 580° C. and less than or equal to 610° C., greater than or equal to 590° C. and less than or equal to 610° C., greater than or equal to 600° C. and less than or equal to 610° C., greater than or equal to 550° C. and less than or equal to 600° C., greater than or equal to 560° C. and less than or equal to 600° C., greater than or equal to 570° C. and less than or equal to 600° C., greater than or equal to 580° C. and less than or equal to 600° C., greater than or equal to 590° C. and less than or equal to 600° C., greater than or equal to 550° C. and less than or equal to 590° C., greater than or equal to 560° C. and less than or equal to 590° C., greater than or equal to 570° C. and less than or equal to 590° C., greater than or equal to 580° C. and less than or equal to 590° C., greater than or equal to 550° C. and less than or equal to 580° C., greater than or equal to 560° C. and less than or equal to 580° C., greater than or equal to 570° C. and less than or equal to 580° C., greater than or equal to 550° C. and less than or equal to 570° C., greater than or equal to 560° C. and less than or equal to 570° C., or greater than or equal to 550° C. and less than or equal to 560° C. It should be understood that the above ranges include all subranges within the explicitly disclosed ranges.

In embodiments, the precursor glass is held at the nucleation temperature for a duration that is greater than or equal to 1 minute to less than or equal to 480 minutes, greater than or equal to 30 minutes to less than or equal to 480 minutes, greater than or equal to 60 minutes to less than or equal to 480 minutes, greater than or equal to 90 minutes to less than or equal to 480 minutes, greater than or equal to 120 minutes to less than or equal to 480 minutes, greater than or equal to 150 minutes to less than or equal to 480 minutes, greater than or equal to 180 minutes to less than or equal to 480 minutes, greater than or equal to 210 minutes to less than or equal to 480 minutes, greater than or equal to 240 minutes to less than or equal to 480 minutes, greater than or equal to 270 minutes to less than or equal to 480 minutes, greater than or equal to 300 minutes to less than or equal to 480 minutes, greater than or equal to 330 minutes to less than or equal to 480 minutes, greater than or equal to 360 minutes to less than or equal to 480 minutes, greater than or equal to 390 minutes to less than or equal to 480 minutes, greater than or equal to 420 minutes to less than or equal to 480 minutes, greater than or equal to 1 minute to less than or equal to 420 minutes, greater than or equal to 30 minutes to less than or equal to 420 minutes, greater than or equal to 60 minutes to less than or equal to 420 minutes, greater than or equal to 90 minutes to less than or equal to 420 minutes, greater than or equal to 120 minutes to less than or equal to 420 minutes, greater than or equal to 150 minutes to less than or equal to 420 minutes, greater than or equal to 180 minutes to less than or equal to 420 minutes, greater than or equal to 210 minutes to less than or equal to 420 minutes, greater than or equal to 240 minutes to less than or equal to 420 minutes, greater than or equal to 270 minutes to less than or equal to 420 minutes, greater than or equal to 300 minutes to less than or equal to 420 minutes, greater than or equal to 330 minutes to less than or equal to 420 minutes, greater than or equal to 360 minutes to less than or equal to 420 minutes, greater than or equal to 390 minutes to less than or equal to 420 minutes, greater than or equal to 1 minute to less than or equal to 360 minutes, greater than or equal to 30 minutes to less than or equal to 360 minutes, greater than or equal to 60 minutes to less than or equal to 360 minutes, greater than or equal to 90 minutes to less than or equal to 360 minutes, greater than or equal to 120 minutes to less than or equal to 360 minutes, greater than or equal to 150 minutes to less than or equal to 360 minutes, greater than or equal to 180 minutes to less than or equal to 360 minutes, greater than or equal to 210 minutes to less than or equal to 360 minutes, greater than or equal to 240 minutes to less than or equal to 360 minutes, greater than or equal to 270 minutes to less than or equal to 360 minutes, greater than or equal to 300 minutes to less than or equal to 360 minutes, greater than or equal to 330 minutes to less than or equal to 360 minutes, greater than or equal to 1 minute to less than or equal to 330 minutes, greater than or equal to 30 minutes to less than or equal to 330 minutes, greater than or equal to 60 minutes to less than or equal to 330 minutes, greater than or equal to 90 minutes to less than or equal to 330 minutes, greater than or equal to 120 minutes to less than or equal to 330 minutes, greater than or equal to 150 minutes to less than or equal to 330 minutes, greater than or equal to 180 minutes to less than or equal to 330 minutes, greater than or equal to 210 minutes to less than or equal to 330 minutes, greater than or equal to 240 minutes to less than or equal to 330 minutes, greater than or equal to 270 minutes to less than or equal to 330 minutes, greater than or equal to 300 minutes to less than or equal to 330 minutes, greater than or equal to 1 minute to less than or equal to 300 minutes, greater than or equal to 30 minutes to less than or equal to 300 minutes, greater than or equal to 60 minutes to less than or equal to 300 minutes, greater than or equal to 90 minutes to less than or equal to 300 minutes, greater than or equal to 120 minutes to less than or equal to 300 minutes, greater than or equal to 150 minutes to less than or equal to 300 minutes, greater than or equal to 180 minutes to less than or equal to 300 minutes, greater than or equal to 210 minutes to less than or equal to 300 minutes, greater than or equal to 240 minutes to less than or equal to 300 minutes, greater than or equal to 270 minutes to less than or equal to 300 minutes, greater than or equal to 1 minute to less than or equal to 270 minutes, greater than or equal to 30 minutes to less than or equal to 270 minutes, greater than or equal to 60 minutes to less than or equal to 270 minutes, greater than or equal to 90 minutes to less than or equal to 270 minutes, greater than or equal to 120 minutes to less than or equal to 270 minutes, greater than or equal to 150 minutes to less than or equal to 270 minutes, greater than or equal to 180 minutes to less than or equal to 270 minutes, greater than or equal to 210 minutes to less than or equal to 270 minutes, greater than or equal to 240 minutes to less than or equal to 270 minutes, greater than or equal to 1 minute to less than or equal to 240 minutes, greater than or equal to 30 minutes to less than or equal to 240 minutes, greater than or equal to 60 minutes to less than or equal to 240 minutes, greater than or equal to 90 minutes to less than or equal to 240 minutes, greater than or equal to 120 minutes to less than or equal to 240 minutes, greater than or equal to 150 minutes to less than or equal to 240 minutes, greater than or equal to 180 minutes to less than or equal to 240 minutes, greater than or equal to 210 minutes to less than or equal to 240 minutes, greater than or equal to 1 minute to less than or equal to 210 minutes, greater than or equal to 30 minutes to less than or equal to 210 minutes, greater than or equal to 60 minutes to less than or equal to 210 minutes, greater than or equal to 90 minutes to less than or equal to 210 minutes, greater than or equal to 120 minutes to less than or equal to 210 minutes, greater than or equal to 150 minutes to less than or equal to 210 minutes, greater than or equal to 180 minutes to less than or equal to 210 minutes, greater than or equal to 1 minute to less than or equal to 180 minutes, greater than or equal to 30 minutes to less than or equal to 180 minutes, greater than or equal to 60 minutes to less than or equal to 180 minutes, greater than or equal to 90 minutes to less than or equal to 180 minutes, greater than or equal to 120 minutes to less than or equal to 180 minutes, greater than or equal to 150 minutes to less than or equal to 180 minutes, greater than or equal to 1 minute to less than or equal to 150 minutes, greater than or equal to 30 minutes to less than or equal to 150 minutes, greater than or equal to 60 minutes to less than or equal to 150 minutes, greater than or equal to 90 minutes to less than or equal to 150 minutes, greater than or equal to 120 minutes to less than or equal to 150 minutes, greater than or equal to 1 minute to less than or equal to 120 minutes, greater than or equal to 30 minutes to less than or equal to 120 minutes, greater than or equal to 60 minutes to less than or equal to 120 minutes, greater than or equal to 90 minutes to less than or equal to 120 minutes, greater than or equal to 1 minute to less than or equal to 90 minutes, greater than or equal to 30 minutes to less than or equal to 90 minutes, greater than or equal to 60 minutes to less than or equal to 90 minutes, greater than or equal to 1 minute to less than or equal to 60 minutes, greater than or equal to 30 minutes to less than or equal to 60 minutes, or greater than or equal to 1 minute to less than or equal to 30 minutes. It should be understood that the above ranges include all subranges within the explicitly disclosed ranges. After the nucleation stage, the precursor glass is referred to as a nucleated precursor glass.

The growth stage takes place when a nucleated precursor glass is held at the predetermined growth temperature for a predetermined duration. The growth temperature is, in embodiments, greater than the nucleation temperature. In embodiments, the growth temperature is greater than or equal to 650° C. and less than or equal to 800° C., greater than or equal to 660° C. and less than or equal to 800° C., greater than or equal to 670° C. and less than or equal to 800° C., the growth temperature is greater than or equal to 680° C. and less than or equal to 800° C., greater than or equal to 690° C. and less than or equal to 800° C., greater than or equal to 700° C. and less than or equal to 800° C., greater than or equal to 710° C. and less than or equal to 800° C., greater than or equal to 720° C. and less than or equal to 800° C., greater than or equal to 730° C. and less than or equal to 800° C., greater than or equal to 740° C. and less than or equal to 800° C., greater than or equal to 750° C. and less than or equal to 800° C., greater than or equal to 760° C. and less than or equal to 800° C., greater than or equal to 770° C. and less than or equal to 800° C., greater than or equal to 780° C. and less than or equal to 800° C., greater than or equal to 790° C. and less than or equal to 800° C., greater than or equal to 650° C. and less than or equal to 790° C., greater than or equal to 660° C. and less than or equal to 790° C., greater than or equal to 670° C. and less than or equal to 790° C., greater than or equal to 680° C. and less than or equal to 790° C., greater than or equal to 690° C. and less than or equal to 790° C., greater than or equal to 700° C. and less than or equal to 790° C., greater than or equal to 710° C. and less than or equal to 790° C., greater than or equal to 720° C. and less than or equal to 790° C., greater than or equal to 730° C. and less than or equal to 790° C., greater than or equal to 740° C. and less than or equal to 790° C., greater than or equal to 750° C. and less than or equal to 790° C., greater than or equal to 760° C. and less than or equal to 790° C., greater than or equal to 770° C. and less than or equal to 790° C., greater than or equal to 780° C. and less than or equal to 790° C., greater than or equal to 650° C. and less than or equal to 780° C., greater than or equal to 660° C. and less than or equal to 780° C., greater than or equal to 670° C. and less than or equal to 780° C., greater than or equal to 680° C. and less than or equal to 780° C., greater than or equal to 690° C. and less than or equal to 780° C., greater than or equal to 700° C. and less than or equal to 780° C., greater than or equal to 710° C. and less than or equal to 780° C., greater than or equal to 720° C. and less than or equal to 780° C., greater than or equal to 730° C. and less than or equal to 780° C., greater than or equal to 740° C. and less than or equal to 780° C., greater than or equal to 750° C. and less than or equal to 780° C., greater than or equal to 760° C. and less than or equal to 780° C., greater than or equal to 770° C. and less than or equal to 780° C., greater than or equal to 650° C. and less than or equal to 770° C., greater than or equal to 660° C. and less than or equal to 770° C., greater than or equal to 670° C. and less than or equal to 770° C., greater than or equal to 680° C. and less than or equal to 770° C., greater than or equal to 690° C. and less than or equal to 770° C., greater than or equal to 700° C. and less than or equal to 770° C., greater than or equal to 710° C. and less than or equal to 770° C., greater than or equal to 720° C. and less than or equal to 770° C., greater than or equal to 730° C. and less than or equal to 770° C., greater than or equal to 740° C. and less than or equal to 770° C., greater than or equal to 750° C. and less than or equal to 770° C., greater than or equal to 760° C. and less than or equal to 770° C., greater than or equal to 650° C. and less than or equal to 760° C., greater than or equal to 660° C. and less than or equal to 760° C., greater than or equal to 670° C. and less than or equal to 760° C., greater than or equal to 680° C. and less than or equal to 760° C., greater than or equal to 690° C. and less than or equal to 760° C., greater than or equal to 700° C. and less than or equal to 760° C., greater than or equal to 710° C. and less than or equal to 760° C., greater than or equal to 720° C. and less than or equal to 760° C., greater than or equal to 730° C. and less than or equal to 760° C., greater than or equal to 740° C. and less than or equal to 760° C., greater than or equal to 750° C. and less than or equal to 760° C., greater than or equal to 650° C. and less than or equal to 750° C., greater than or equal to 660° C. and less than or equal to 750° C., greater than or equal to 670° C. and less than or equal to 750° C., greater than or equal to 680° C. and less than or equal to 750° C., greater than or equal to 690° C. and less than or equal to 750° C., greater than or equal to 700° C. and less than or equal to 750° C., greater than or equal to 710° C. and less than or equal to 750° C., greater than or equal to 720° C. and less than or equal to 750° C., greater than or equal to 730° C. and less than or equal to 750° C., greater than or equal to 740° C. and less than or equal to 750° C., greater than or equal to 650° C. and less than or equal to 750° C., greater than or equal to 660° C. and less than or equal to 750° C., greater than or equal to 670° C. and less than or equal to 750° C., greater than or equal to 650° C. and less than or equal to 740° C., greater than or equal to 660° C. and less than or equal to 740° C., greater than or equal to 670° C. and less than or equal to 740° C., greater than or equal to 680° C. and less than or equal to 740° C., greater than or equal to 690° C. and less than or equal to 740° C., greater than or equal to 700° C. and less than or equal to 740° C., greater than or equal to 710° C. and less than or equal to 740° C., greater than or equal to 720° C. and less than or equal to 740° C., greater than or equal to 730° C. and less than or equal to 740° C., greater than or equal to 650° C. and less than or equal to 740° C., greater than or equal to 660° C. and less than or equal to 740° C., greater than or equal to 670° C. and less than or equal to 740° C., greater than or equal to 650° C. and less than or equal to 730° C., greater than or equal to 660° C. and less than or equal to 730° C., greater than or equal to 670° C. and less than or equal to 730° C., greater than or equal to 680° C. and less than or equal to 730° C., greater than or equal to 690° C. and less than or equal to 730° C., greater than or equal to 700° C. and less than or equal to 730° C., greater than or equal to 710° C. and less than or equal to 730° C., greater than or equal to 720° C. and less than or equal to 730° C., greater than or equal to 650° C. and less than or equal to 720° C., greater than or equal to 660° C. and less than or equal to 720° C., greater than or equal to 670° C. and less than or equal to 720° C., greater than or equal to 680° C. and less than or equal to 720° C., greater than or equal to 690° C. and less than or equal to 720° C., greater than or equal to 700° C. and less than or equal to 720° C., greater than or equal to 710° C. and less than or equal to 720° C., greater than or equal to 650° C. and less than or equal to 710° C., greater than or equal to 660° C. and less than or equal to 710° C., greater than or equal to 670° C. and less than or equal to 710° C., greater than or equal to 680° C. and less than or equal to 710° C., greater than or equal to 690° C. and less than or equal to 710° C., greater than or equal to 700° C. and less than or equal to 710° C., greater than or equal to 650° C. and less than or equal to 700° C., greater than or equal to 660° C. and less than or equal to 700° C., greater than or equal to 670° C. and less than or equal to 700° C., greater than or equal to 680° C. and less than or equal to 700° C., greater than or equal to 690° C. and less than or equal to 700° C., greater than or equal to 650° C. and less than or equal to 690° C., greater than or equal to 660° C. and less than or equal to 690° C., greater than or equal to 670° C. and less than or equal to 690° C., or greater than or equal to 680° C. and less than or equal to 690° C. It should be understood that the above ranges include all subranges within the explicitly disclosed ranges.

In embodiments, the nucleated precursor glass is held at the growth temperature for a duration that is greater than or equal to 1 minute to less than or equal to 240 minutes, greater than or equal to 30 minutes to less than or equal to 240 minutes, greater than or equal to 60 minutes to less than or equal to 240 minutes, greater than or equal to 90 minutes to less than or equal to 240 minutes, greater than or equal to 120 minutes to less than or equal to 240 minutes, greater than or equal to 150 minutes to less than or equal to 240 minutes, greater than or equal to 180 minutes to less than or equal to 240 minutes, greater than or equal to 210 minutes to less than or equal to 240 minutes, greater than or equal to 1 minute to less than or equal to 240 minutes, greater than or equal to 30 minutes to less than or equal to 240 minutes, greater than or equal to 60 minutes to less than or equal to 240 minutes, greater than or equal to 90 minutes to less than or equal to 240 minutes, greater than or equal to 120 minutes to less than or equal to 240 minutes, greater than or equal to 150 minutes to less than or equal to 240 minutes, greater than or equal to 180 minutes to less than or equal to 240 minutes, greater than or equal to 210 minutes to less than or equal to 240 minutes, greater than or equal to 1 minute to less than or equal to 210 minutes, greater than or equal to 30 minutes to less than or equal to 210 minutes, greater than or equal to 60 minutes to less than or equal to 210 minutes, greater than or equal to 90 minutes to less than or equal to 210 minutes, greater than or equal to 120 minutes to less than or equal to 210 minutes, greater than or equal to 150 minutes to less than or equal to 210 minutes, greater than or equal to 180 minutes to less than or equal to 210 minutes, greater than or equal to 1 minute to less than or equal to 180 minutes, greater than or equal to 30 minutes to less than or equal to 180 minutes, greater than or equal to 60 minutes to less than or equal to 180 minutes, greater than or equal to 90 minutes to less than or equal to 180 minutes, greater than or equal to 120 minutes to less than or equal to 180 minutes, greater than or equal to 150 minutes to less than or equal to 180 minutes, greater than or equal to 1 minute to less than or equal to 150 minutes, greater than or equal to 30 minutes to less than or equal to 150 minutes, greater than or equal to 60 minutes to less than or equal to 150 minutes, greater than or equal to 90 minutes to less than or equal to 150 minutes, greater than or equal to 120 minutes to less than or equal to 150 minutes, greater than or equal to 1 minute to less than or equal to 120 minutes, greater than or equal to 30 minutes to less than or equal to 120 minutes, greater than or equal to 60 minutes to less than or equal to 120 minutes, greater than or equal to 90 minutes to less than or equal to 120 minutes, greater than or equal to 1 minute to less than or equal to 90 minutes, greater than or equal to 30 minutes to less than or equal to 90 minutes, greater than or equal to 60 minutes to less than or equal to 90 minutes, greater than or equal to 1 minute to less than or equal to 60 minutes, greater than or equal to 30 minutes to less than or equal to 60 minutes, or greater than or equal to 1 minute to less than or equal to 30 minutes. It should be understood that the above ranges include all subranges within the explicitly disclosed ranges. The growth stage transitions the nucleated precursor glass into a glass-ceramic material (i.e., a glass-ceramic or glass-ceramic article).

A precursor glass article as disclosed and described herein held at the nucleation temperature and growth temperature for the durations disclosed and described herein will form a glass-ceramic having a phase assemblage comprising a residual amorphous glass phase, a petalite (LiAlSi₄O₁₀) crystalline phase, and a lithium disilicate (Li₂Si₂O₅) crystalline phase. In addition, the precursor glass held at the nucleation temperature and the growth temperature for the durations disclosed herein will form copper metal nanoparticles dispersed in the residual amorphous glass phase. As noted herein, copper metal nanoparticles impart a desired red color to the glass-ceramic.

It is believed that the nucleation and growth temperatures and durations disclosed and described herein are the heat treatments that primarily result in the desired phase assemblage in the glass-ceramics, including the copper metal nanoparticles that impart the desired red color to the glass-ceramic. Additional heat treatments may be included before the nucleation stage, between the nucleation stage and the growth stage, and after the growth stage without causing significant deviation in the phase assemblage of the glass-ceramic material. These additional heat treatments include isothermal holds, heating at specific heating schedules including a number of differing heating rates, and combinations thereof.

Accordingly, in embodiments, there may be one of more additional temperature holds between the nucleation temperature and the growth temperature. In embodiments, after maintaining the precursor glass at the nucleation temperature, the article may be heated to one or more intermediate temperatures (wherein the intermediate temperatures are in a range between the nucleation temperature and the growth temperature) and held at the one or more intermediate temperatures for a predetermined time (for example, between 1 minute and 360 minutes and all ranges and subranges there between) and then heated to the growth temperature.

In embodiments, the nucleation stage comprises an isothermal hold at a single nucleation temperature for a duration. However, in other embodiments, the nucleation stage includes heating the precursor glass at one or more heating rates through the nucleation temperature range described herein (i.e., from greater than or equal to 550° C. to less than 650° C.). Likewise, in embodiments, the growth stage comprises an isothermal hold at a single growth temperature for a duration. However, in other embodiments, the growth stage includes heating or cooling the nucleated precursor glass at one or more heating rates within the growth temperature range described herein (i.e., from greater than or equal to 650° C. to less than or equal to 800° C.).

According to embodiments, heating rates used to heat from room temperature to the nucleation temperature, within the nucleation stage, between the nucleation stage and the growth stage, within the growth stage, and after the growth stage is greater than or equal to 0.1° C./min and less than or equal to 50° C./min, greater than or equal to 5° C./min and less than or equal to 50° C./min, greater than or equal to 10° C./min and less than or equal to 50° C./min, greater than or equal to 15° C./min and less than or equal to 50° C./min, greater than or equal to 20° C./min and less than or equal to 50° C./min, greater than or equal to 25° C./min and less than or equal to 50° C./min, greater than or equal to 30° C./min and less than or equal to 50° C./min, greater than or equal to 35° C./min and less than or equal to 50° C./min, greater than or equal to 40° C./min and less than or equal to 50° C./min, greater than or equal to 45° C./min and less than or equal to 50° C./min, greater than or equal to 0.1° C./min and less than or equal to 45° C./min, greater than or equal to 5° C./min and less than or equal to 45° C./min, greater than or equal to 10° C./min and less than or equal to 45° C./min, greater than or equal to 15° C./min and less than or equal to 45° C./min, greater than or equal to 20° C./min and less than or equal to 45° C./min, greater than or equal to 25° C./min and less than or equal to 45° C./min, greater than or equal to 30° C./min and less than or equal to 45° C./min, greater than or equal to 35° C./min and less than or equal to 45° C./min, greater than or equal to 40° C./min and less than or equal to 45° C./min, greater than or equal to 0.1° C./min and less than or equal to 40° C./min, greater than or equal to 5° C./min and less than or equal to 40° C./min, greater than or equal to 10° C./min and less than or equal to 40° C./min, greater than or equal to 15° C./min and less than or equal to 40° C./min, greater than or equal to 20° C./min and less than or equal to 40° C./min, greater than or equal to 25° C./min and less than or equal to 40° C./min, greater than or equal to 30° C./min and less than or equal to 40° C./min, greater than or equal to 35° C./min and less than or equal to 40° C./min, greater than or equal to 0.1° C./min and less than or equal to 35° C./min, greater than or equal to 5° C./min and less than or equal to 35° C./min, greater than or equal to 10° C./min and less than or equal to 35° C./min, greater than or equal to 15° C./min and less than or equal to 35° C./min, greater than or equal to 20° C./min and less than or equal to 35° C./min, greater than or equal to 25° C./min and less than or equal to 35° C./min, greater than or equal to 30° C./min and less than or equal to 35° C./min, greater than or equal to 0.1° C./min and less than or equal to 30° C./min, greater than or equal to 5° C./min and less than or equal to 30° C./min, greater than or equal to 10° C./min and less than or equal to 30° C./min, greater than or equal to 15° C./min and less than or equal to 30° C./min, greater than or equal to 20° C./min and less than or equal to 30° C./min, greater than or equal to 25° C./min and less than or equal to 30° C./min, greater than or equal to 0.1° C./min and less than or equal to 25° C./min, greater than or equal to 5° C./min and less than or equal to 25° C./min, greater than or equal to 10° C./min and less than or equal to 25° C./min, greater than or equal to 15° C./min and less than or equal to 25° C./min, greater than or equal to 20° C./min and less than or equal to 25° C./min, greater than or equal to 0.1° C./min and less than or equal to 20° C./min, greater than or equal to 5° C./min and less than or equal to 20° C./min, greater than or equal to 10° C./min and less than or equal to 20° C./min, greater than or equal to 15° C./min and less than or equal to 20° C./min, greater than or equal to 0.1° C./min and less than or equal to 15° C./min, greater than or equal to 5° C./min and less than or equal to 15° C./min, greater than or equal to 10° C./min and less than or equal to 15° C./min, greater than or equal to 0.1° C./min and less than or equal to 10° C./min, greater than or equal to 5° C./min and less than or equal to 10° C./min, or greater than or equal to 0.1° C./min and less than or equal to 5° C./min. It should be understood that the above ranges include all subranges within the explicitly disclosed ranges. Such heating rates allow the proper amount of nucleation and crystal growth without damaging the glass-ceramic article. If heating is done to quickly, the material may be damaged. However, if heating is done too slowly, proper nucleation and growth may not occur.

In embodiments, the glass-ceramic is cooled after being held at the growth temperature. In embodiments, the glass-ceramic may be cooled to room temperature in a single stage at a constant cooling rate, in two stages each with a different cooling rate, or in three or more stages each with a different cooling rate. In embodiments, the glass-ceramics are cooled at a controlled rate from the growth temperature to minimize temperature gradients across the articles as well as minimize residual stress across the articles. Temperature gradients and differences in residual stress may lead to the articles warping during cooling. Thus, controlling the cooling to control the temperature gradients and residual stresses may also minimize warpage of the glass-ceramics.

The grain size of the crystals in the crystalline phases (i.e., the petalite crystalline phase and the lithium disilicate crystalline phase) is a factor that affects the transmittance of the glass-ceramics. In embodiments, the grains have a longest dimension in a range from about 5 nm to about 150 nm, about 5 nm to about 125 nm, about 5 nm to about 100 nm, about 5 nm to about 75 nm, about 5 nm to about 50 nm, about 25 nm to about 150 nm, about 25 nm to about 125 nm, about 25 nm to about 100 nm, about 25 nm to about 75 nm, about 50 nm to about 150 nm, about 50 nm to about 125 nm, about 50 nm to about 100 nm, and all ranges and subranges there between. In embodiments, the longest dimension of the grains is less than 150 nm, less than 125 nm, less than 100 nm, less than 75 nm, less than 50 nm, or less than 25 nm. The longest dimension of the grains is measured using a scanning electron microscope (SEM) and image analysis.

As noted herein, the copper metal nanoparticles dispersed in the residual amorphous glass phase have a size distribution such that the peak position of the largest dimension of the copper metal nanoparticles is in the range from greater than or equal to 20 nm to less than or equal to 40 nm. If the peak position of the largest dimension of the copper metal nanoparticles in the size distribution is less than 20 nm, the desired color is not as pronounced. If the peak position of the largest dimension of the copper metal nanoparticles in the size distribution is greater than 50 nm, the particles diffract light differently and the desired color may not be achieved.

In embodiments, glass-ceramics and glass-ceramic articles may be strengthened to install a compressive stress layer on one or more surface thereof. Referring now to FIG. 2 by way of example, an exemplary cross-sectional side view of a strengthened glass-ceramic article 100 is depicted having a first surface 102 and an opposing second surface 104 separated by a thickness (t). In embodiments, the strengthened glass-ceramic article 100 has been ion exchanged and has a compressive stress (CS) layer 106 (or first region) extending from the first surface 102 to a depth of compression (DOC). In embodiments, as shown in FIG. 2, the glass-ceramic article 100 also has a compressive stress (CS) layer 108 extending from the second surface 104 to a depth of compression DOC′. A central tension region 110 having a central tension (CT) is positioned between DOC and DOC′.

In embodiments, the glass-ceramics and glass-ceramic articles are capable of being chemically tempered (also referred to as chemically strengthened) using one or more ion exchange techniques. In these embodiments, ion exchange can occur by subjecting one or more surfaces of such glass-ceramic or glass-ceramic article to one or more ion exchange mediums (for example molten salt baths), having a specific composition and temperature, for a specified time period to impart to the one or more surfaces with compressive stress layer(s). In embodiments, the ion exchange medium is a molten salt bath containing an ion (for example an alkali metal ion) that is larger than an ion (for example an alkali metal ion) present in the glass-ceramic or glass-ceramic article wherein the larger ion from the molten bath is exchanged with the smaller ion in the glass-ceramic article to impart a compressive stress in the glass-ceramic or glass-ceramic article, and thereby increases the strength of the glass-ceramic or glass-ceramic article.

In embodiments, a one-step ion exchange process can be used. In other embodiments, a multi-step ion exchange process (such as a two-step ion exchange process) can be used. In embodiments, for both one-step and multi-step ion exchange processes, the ion exchange mediums (for example, molten baths) can include potassium nitrate (KNO₃) and sodium nitrate (NaNO₃) as primary components. The ion exchange mediums can, in embodiments, further comprise lithium nitrate (LiNO₃), sodium nitrite (NaNO₂), and silicic acid.

In embodiments, the ion exchange medium comprises greater than or equal to 50 wt % and less than or equal to 70 wt % KNO₃, greater than or equal to 55 wt % and less than or equal to 70 wt % KNO₃, greater than or equal to 60 wt % and less than or equal to 70 wt % KNO₃, greater than or equal to 65 wt % and less than or equal to 70 wt % KNO₃, greater than or equal to 50 wt % and less than or equal to 65 wt % KNO₃, greater than or equal to 55 wt % and less than or equal to 65 wt % KNO₃, greater than or equal to 60 wt % and less than or equal to 65 wt % KNO₃, greater than or equal to 50 wt % and less than or equal to 60 wt % KNO₃, greater than or equal to 55 wt % and less than or equal to 60 wt % KNO₃, or greater than or equal to 50 wt % and less than or equal to 55 wt % KNO₃. It should be understood that the above ranges include all subranges within the explicitly disclosed ranges.

In embodiments, the ion exchange medium comprises greater than or equal to 30 wt % and less than or equal to 80 wt % NaNO₃, greater than or equal to 30 wt % and less than or equal to 75 wt % NaNO₃, greater than or equal to 30 wt % and less than or equal to 70 wt % NaNO₃, greater than or equal to 30 wt % and less than or equal to 65 wt % NaNO₃, greater than or equal to 30 wt % and less than or equal to 60 wt % NaNO₃, greater than or equal to 30 wt % and less than or equal to 55 wt % NaNO₃, greater than or equal to 30 wt % and less than or equal to 50 wt % NaNO₃, greater than or equal to 35 wt % and less than or equal to 80 wt % NaNO₃, greater than or equal to 35 wt % and less than or equal to 75 wt % NaNO₃, greater than or equal to 35 wt % and less than or equal to 70 wt % NaNO₃, greater than or equal to 35 wt % and less than or equal to 65 wt % NaNO₃, greater than or equal to 35 wt % and less than or equal to 60 wt % NaNO₃, greater than or equal to 35 wt % and less than or equal to 55 wt % NaNO₃, greater than or equal to 35 wt % and less than or equal to 50 wt % NaNO₃, greater than or equal to 40 wt % and less than or equal to 80 wt % NaNO₃, greater than or equal to 40 wt % and less than or equal to 75 wt % NaNO₃, greater than or equal to 40 wt % and less than or equal to 70 wt % NaNO₃, greater than or equal to 40 wt % and less than or equal to 65 wt % NaNO₃, greater than or equal to 40 wt % and less than or equal to 60 wt % NaNO₃, greater than or equal to 40 wt % and less than or equal to 55 wt % NaNO₃, greater than or equal to 40 wt % and less than or equal to 50 wt % NaNO₃, greater than or equal to 45 wt % and less than or equal to 80 wt % NaNO₃, greater than or equal to 45 wt % and less than or equal to 75 wt % NaNO₃, greater than or equal to 45 wt % and less than or equal to 70 wt % NaNO₃, greater than or equal to 45 wt % and less than or equal to 65 wt % NaNO₃, greater than or equal to 45 wt % and less than or equal to 60 wt % NaNO₃, greater than or equal to 45 wt % and less than or equal to 55 wt % NaNO₃, greater than or equal to 45 wt % and less than or equal to 50 wt % NaNO₃, greater than or equal to 30 wt % and less than or equal to 45 wt % NaNO₃, greater than or equal to 35 wt % and less than or equal to 45 wt % NaNO₃, greater than or equal to 40 wt % and less than or equal to 45 wt % NaNO₃, greater than or equal to 30 wt % and less than or equal to 40 wt % NaNO₃, greater than or equal to 35 wt % and less than or equal to 40 wt % NaNO₃, or greater than or equal to 30 wt % and less than or equal to 35 wt % NaNO₃. It should be understood that the above ranges include all subranges within the explicitly disclosed ranges.

In embodiments, the ion exchange medium comprises greater than or equal to 0.05 wt % and less than or equal to 0.25 wt % LiNO₃, greater than or equal to 0.08 wt % and less than or equal to 0.25 wt % LiNO₃, greater than or equal to 0.10 wt % and less than or equal to 0.25 wt % LiNO₃, greater than or equal to 0.15 wt % and less than or equal to 0.25 wt % LiNO₃, greater than or equal to 0.20 wt % and less than or equal to 0.25 wt % LiNO₃, greater than or equal to 0.05 wt % and less than or equal to 0.20 wt % LiNO₃, greater than or equal to 0.08 wt % and less than or equal to 0.20 wt % LiNO₃, greater than or equal to 0.10 wt % and less than or equal to 0.20 wt % LiNO₃, greater than or equal to 0.15 wt % and less than or equal to 0.20 wt % LiNO₃, greater than or equal to 0.05 wt % and less than or equal to 0.15 wt % LiNO₃, greater than or equal to 0.08 wt % and less than or equal to 0.15 wt % LiNO₃, greater than or equal to 0.10 wt % and less than or equal to 0.15 wt % LiNO₃, greater than or equal to 0.12 wt % and less than or equal to 0.15 wt % LiNO₃, greater than or equal to 0.05 wt % and less than or equal to 0.12 wt % LiNO₃, greater than or equal to 0.08 wt % and less than or equal to 0.12 wt % LiNO₃, greater than or equal to 0.10 wt % and less than or equal to 0.12 wt % LiNO₃, greater than or equal to 0.05 wt % and less than or equal to 0.10 wt % LiNO₃, greater than or equal to 0.08 wt % and less than or equal to 0.10 wt % LiNO₃, or greater than or equal to 0.05 wt % and less than or equal to 0.08 wt % LiNO₃. It should be understood that the above ranges include all subranges within the explicitly disclosed ranges.

In embodiments, the ion exchange medium comprises greater than or equal to 0.40 wt % and less than or equal to 0.60 wt % silicic acid, greater than or equal to 0.45 wt % and less than or equal to 0.60 wt % silicic acid, greater than or equal to 0.50 wt % and less than or equal to 0.60 wt % silicic acid, greater than or equal to 0.55 wt % and less than or equal to 0.60 wt % silicic acid, greater than or equal to 0.40 wt % and less than or equal to 0.55 wt % silicic acid, greater than or equal to 0.45 wt % and less than or equal to 0.55 wt % silicic acid, greater than or equal to 0.50 wt % and less than or equal to 0.55 wt % silicic acid, greater than or equal to 0.40 wt % and less than or equal to 0.50 wt % silicic acid, greater than or equal to 0.45 wt % and less than or equal to 0.50 wt % silicic acid, or greater than or equal to 0.40 wt % and less than or equal to 0.45 wt %. It should be understood that the above ranges include all subranges within the explicitly disclosed ranges.

The temperature of the ion exchange medium is, in embodiments, greater than or equal to 430° C. and less than or equal to 550° C., greater than or equal to 450° C. and less than or equal to 550° C., greater than or equal to 475° C. and less than or equal to 550° C., greater than or equal to 500° C. and less than or equal to 550° C., greater than or equal to 525° C. and less than or equal to 550° C., greater than or equal to 530° C. and less than or equal to 550° C., greater than or equal to 430° C. and less than or equal to 530° C., greater than or equal to 450° C. and less than or equal to 530° C., greater than or equal to 475° C. and less than or equal to 530° C., greater than or equal to 500° C. and less than or equal to 530° C., greater than or equal to 525° C. and less than or equal to 530° C., greater than or equal to 430° C. and less than or equal to 525° C., greater than or equal to 450° C. and less than or equal to 525° C., greater than or equal to 475° C. and less than or equal to 525° C., greater than or equal to 500° C. and less than or equal to 525° C., greater than or equal to 430° C. and less than or equal to 500° C., greater than or equal to 450° C. and less than or equal to 500° C., greater than or equal to 475° C. and less than or equal to 500° C., or greater than or equal to 450° C. and less than or equal to 475° C. It should be understood that the above ranges include all subranges within the explicitly disclosed ranges.

According to embodiments, the glass-ceramic or glass-ceramic article is contacted with the ion exchange medium for a duration that is greater than or equal to 1 hour and less than or equal to 16 hours, greater than or equal to 2 hour and less than or equal to 16 hours, greater than or equal to 4 hour and less than or equal to 16 hours, greater than or equal to 6 hour and less than or equal to 16 hours, greater than or equal to 8 hour and less than or equal to 16 hours, greater than or equal to 10 hour and less than or equal to 16 hours, greater than or equal to 12 hour and less than or equal to 16 hours, greater than or equal to 14 hour and less than or equal to 16 hours, greater than or equal to 1 hour and less than or equal to 14 hours, greater than or equal to 2 hour and less than or equal to 14 hours, greater than or equal to 4 hour and less than or equal to 14 hours, greater than or equal to 6 hour and less than or equal to 14 hours, greater than or equal to 8 hour and less than or equal to 14 hours, greater than or equal to 10 hour and less than or equal to 14 hours, greater than or equal to 12 hour and less than or equal to 14 hours, greater than or equal to 1 hour and less than or equal to 12 hours, greater than or equal to 2 hour and less than or equal to 12 hours, greater than or equal to 4 hour and less than or equal to 12 hours, greater than or equal to 6 hour and less than or equal to 12 hours, greater than or equal to 8 hour and less than or equal to 12 hours, greater than or equal to 10 hour and less than or equal to 12 hours, greater than or equal to 1 hour and less than or equal to 10 hours, greater than or equal to 2 hour and less than or equal to 10 hours, greater than or equal to 4 hour and less than or equal to 10 hours, greater than or equal to 6 hour and less than or equal to 10 hours, greater than or equal to 8 hour and less than or equal to 10 hours, greater than or equal to 1 hour and less than or equal to 8 hours, greater than or equal to 2 hour and less than or equal to 8 hours, greater than or equal to 4 hour and less than or equal to 8 hours, greater than or equal to 6 hour and less than or equal to 8 hours, greater than or equal to 1 hour and less than or equal to 6 hours, greater than or equal to 2 hour and less than or equal to 6 hours, greater than or equal to 4 hour and less than or equal to 6 hours, greater than or equal to 1 hour and less than or equal to 4 hours, greater than or equal to 2 hour and less than or equal to 4 hours, or greater than or equal to 1 hour and less than or equal to 2 hours. It should be understood that the above ranges include all subranges within the explicitly disclosed ranges.

After an ion exchange process is performed, it should be understood that a composition at the surface of the glass-ceramic may be different from the composition of the as-formed glass-ceramic (i.e., the glass-ceramic before it undergoes an ion exchange process). This results from one type of alkali metal ion in the as-formed glass-ceramic, such as, for example Li or Na, being replaced with larger alkali metal ions, such as, for example Na or K, respectively. However, in embodiments, the composition of the glass-ceramic at or near the center of the depth of the glass-ceramic may still have the composition of the as-formed glass-ceramic. In other embodiments, the composition of the glass-ceramic at or near the center of the depth of the glass-ceramic may be different from the composition of the as-formed glass-ceramic. As utilized herein, the center of the glass-ceramic article refers to any location in the glass-ceramic article that is a distance of at least 0.5/from every surface thereof, where t is the thickness of the glass-ceramic or glass-ceramic article.

The mechanical properties of the glass-ceramics disclosed herein are tested on strengthened glass-ceramic articles unless otherwise indicated. By forming a glass-ceramic having a composition as disclosed and described herein, using the heat treatments and chemical strengthening as disclosed and described herein, glass-ceramics with phase assemblages that provide improved mechanical properties (as described in detail below) can be achieved. Even though described in separate paragraphs below, the various mechanical properties are present in combination in glass-ceramics of embodiments. The balance of these mechanical properties provide a durable, robust glass-ceramic that is difficult to achieve without sacrificing other mechanical properties. For instance, and as an example only, achieving high compressive stress alone is possible, but achieving high compressive stress and central tension can be more difficult.

In embodiments, the depths of compression from each surface, DOC and DOC′, are individually greater than or equal to 0.05 t and less than or equal to 0.30 t, greater than or equal to 0.06 t and less than or equal to 0.30 t, greater than or equal to 0.07 t and less than or equal to 0.30 t, greater than or equal to 0.08 t and less than or equal to 0.30 t, greater than or equal to 0.09 t and less than or equal to 0.30 t, greater than or equal to 0.10 t and less than or equal to 0.30 t, greater than or equal to 0.11 t and less than or equal to 0.30 t, greater than or equal to 0.12 t and less than or equal to 0.30 t, greater than or equal to 0.13 t and less than or equal to 0.30 t, greater than or equal to 0.14 t and less than or equal to 0.30 t, greater than or equal to 0.15 t and less than or equal to 0.30 t, greater than or equal to 0.16 t and less than or equal to 0.30 t, greater than or equal to 0.17 t and less than or equal to 0.30 t, greater than or equal to 0.18 t and less than or equal to 0.30 t, greater than or equal to 0.19 t and less than or equal to 0.30 t, greater than or equal to 0.20 t and less than or equal to 0.30 t, greater than or equal to 0.21 t and less than or equal to 0.30 t, greater than or equal to 0.22 t and less than or equal to 0.30 t, greater than or equal to 0.23 t and less than or equal to 0.30 t, greater than or equal to 0.24 t and less than or equal to 0.30 t, greater than or equal to 0.05 t and less than or equal to 0.25 t, greater than or equal to 0.06 t and less than or equal to 0.25 t, greater than or equal to 0.07 t and less than or equal to 0.25 t, greater than or equal to 0.08 t and less than or equal to 0.25 t, greater than or equal to 0.09 t and less than or equal to 0.25 t, greater than or equal to 0.10 t and less than or equal to 0.25 t, greater than or equal to 0.11 t and less than or equal to 0.25 t, greater than or equal to 0.12 t and less than or equal to 0.25 t, greater than or equal to 0.13 t and less than or equal to 0.25 t, greater than or equal to 0.14 t and less than or equal to 0.25 t, greater than or equal to 0.15 t and less than or equal to 0.25 t, greater than or equal to 0.16 t and less than or equal to 0.25 t, greater than or equal to 0.17 t and less than or equal to 0.25 t, greater than or equal to 0.18 t and less than or equal to 0.25 t, greater than or equal to 0.19 t and less than or equal to 0.25 t, greater than or equal to 0.20 t and less than or equal to 0.25 t, greater than or equal to 0.21 t and less than or equal to 0.25 t, greater than or equal to 0.22 t and less than or equal to 0.25 t, greater than or equal to 0.23 t and less than or equal to 0.25 t, greater than or equal to 0.24 t and less than or equal to 0.25 t, greater than or equal to 0.05 t and less than or equal to 0.24 t, greater than or equal to 0.06 t and less than or equal to 0.24 t, greater than or equal to 0.07 t and less than or equal to 0.24 t, greater than or equal to 0.08 t and less than or equal to 0.24 t, greater than or equal to 0.09 t and less than or equal to 0.24 t, greater than or equal to 0.10 t and less than or equal to 0.24 t, greater than or equal to 0.11 t and less than or equal to 0.24 t, greater than or equal to 0.12 t and less than or equal to 0.24 t, greater than or equal to 0.13 t and less than or equal to 0.24 t, greater than or equal to 0.14 t and less than or equal to 0.24 t, greater than or equal to 0.15 t and less than or equal to 0.24 t, greater than or equal to 0.16 t and less than or equal to 0.24 t, greater than or equal to 0.17 and less than or equal to 0.24 t, greater than or equal to 0.18 t and less than or equal to 0.24 t, greater than or equal to 0.19 t and less than or equal to 0.24 t, greater than or equal to 0.20 t and less than or equal to 0.24 t, greater than or equal to 0.21 t and less than or equal to 0.24 t, greater than or equal to 0.22 t and less than or equal to 0.24 t, greater than or equal to 0.23 t and less than or equal to 0.24 t, greater than or equal to 0.05 t and less than or equal to 0.23 t, greater than or equal to 0.06 t and less than or equal to 0.23 t, greater than or equal to 0.07 t and less than or equal to 0.23 t, greater than or equal to 0.08 t and less than or equal to 0.23 t, greater than or equal to 0.09 t and less than or equal to 0.23 t, greater than or equal to 0.10 t and less than or equal to 0.23 t, greater than or equal to 0.11 t and less than or equal to 0.23 t, greater than or equal to 0.12 t and less than or equal to 0.23 t, greater than or equal to 0.13 t and less than or equal to 0.23 t, greater than or equal to 0.14 t and less than or equal to 0.23 t, greater than or equal to 0.15 t and less than or equal to 0.23 t, greater than or equal to 0.16 t and less than or equal to 0.23 t, greater than or equal to 0.17 t and less than or equal to 0.23 t, greater than or equal to 0.18 t and less than or equal to 0.23 t, greater than or equal to 0.19 t and less than or equal to 0.23 t, greater than or equal to 0.20 t and less than or equal to 0.23 t, greater than or equal to 0.21 t and less than or equal to 0.23 t, greater than or equal to 0.22 t and less than or equal to 0.23 t, greater than or equal to 0.05 t and less than or equal to 0.22 t, greater than or equal to 0.06 t and less than or equal to 0.22 t, greater than or equal to 0.07 t and less than or equal to 0.22 t, greater than or equal to 0.08 t and less than or equal to 0.22 t, greater than or equal to 0.09 t and less than or equal to 0.22 t, greater than or equal to 0.10 t and less than or equal to 0.22 t, greater than or equal to 0.11 t and less than or equal to 0.22 t, greater than or equal to 0.12 t and less than or equal to 0.22 t, greater than or equal to 0.13 t and less than or equal to 0.22 t, greater than or equal to 0.14 t and less than or equal to 0.22 t, greater than or equal to 0.15 t and less than or equal to 0.22 t, greater than or equal to 0.16 t and less than or equal to 0.22 t, greater than or equal to 0.17 t and less than or equal to 0.22 t, greater than or equal to 0.18 t and less than or equal to 0.22 t, greater than or equal to 0.19 t and less than or equal to 0.22 t, greater than or equal to 0.20 t and less than or equal to 0.22 t, greater than or equal to 0.21 t and less than or equal to 0.22 t, greater than or equal to 0.05 t and less than or equal to 0.21 t, greater than or equal to 0.06 t and less than or equal to 0.21 t, greater than or equal to 0.07 t and less than or equal to 0.21 t, greater than or equal to 0.08 t and less than or equal to 0.21 t, greater than or equal to 0.09 t and less than or equal to 0.21 t, greater than or equal to 0.10 t and less than or equal to 0.21 t, greater than or equal to 0.11 t and less than or equal to 0.21 t, greater than or equal to 0.12 t and less than or equal to 0.21 t, greater than or equal to 0.13 t and less than or equal to 0.21 t, greater than or equal to 0.14 t and less than or equal to 0.21 t, greater than or equal to 0.15 t and less than or equal to 0.21 t, greater than or equal to 0.16 t and less than or equal to 0.21 t, greater than or equal to 0.17 t and less than or equal to 0.21 t, greater than or equal to 0.18 t and less than or equal to 0.21 t, greater than or equal to 0.19 t and less than or equal to 0.21 t, greater than or equal to 0.20 t and less than or equal to 0.21 t, greater than or equal to 0.05 t and less than or equal to 0.20 t, greater than or equal to 0.06 t and less than or equal to 0.20 t, greater than or equal to 0.07 t and less than or equal to 0.20 t, greater than or equal to 0.08 t and less than or equal to 0.20 t, greater than or equal to 0.09 t and less than or equal to 0.20 t, greater than or equal to 0.10 t and less than or equal to 0.20 t, greater than or equal to 0.11 t and less than or equal to 0.20 t, greater than or equal to 0.12 t and less than or equal to 0.20 t, greater than or equal to 0.13 t and less than or equal to 0.20 t, greater than or equal to 0.14 t and less than or equal to 0.20 t, greater than or equal to 0.15 t and less than or equal to 0.20 t, greater than or equal to 0.16 t and less than or equal to 0.20 t, greater than or equal to 0.17 t and less than or equal to 0.20 t, greater than or equal to 0.18 t and less than or equal to 0.20 t, greater than or equal to 0.19 t and less than or equal to 0.20 t, greater than or equal to 0.05 t and less than or equal to 0.19 t, greater than or equal to 0.06 t and less than or equal to 0.19 t, greater than or equal to 0.07 t and less than or equal to 0.19 t, greater than or equal to 0.08 t and less than or equal to 0.19 t, greater than or equal to 0.09 t and less than or equal to 0.19 t, greater than or equal to 0.10 t and less than or equal to 0.19 t, greater than or equal to 0.11 t and less than or equal to 0.19 t, greater than or equal to 0.12 t and less than or equal to 0.19 t, greater than or equal to 0.13 t and less than or equal to 0.19 t, greater than or equal to 0.14 t and less than or equal to 0.19 t, greater than or equal to 0.15 t and less than or equal to 0.19 t, greater than or equal to 0.16 t and less than or equal to 0.19 t, greater than or equal to 0.17 t and less than or equal to 0.19 t, greater than or equal to 0.18 t and less than or equal to 0.19 t, greater than or equal to 0.05 t and less than or equal to 0.18 t, greater than or equal to 0.06 t and less than or equal to 0.18 t, greater than or equal to 0.07 t and less than or equal to 0.18 t, greater than or equal to 0.08 t and less than or equal to 0.18 t, greater than or equal to 0.09 t and less than or equal to 0.18 t, greater than or equal to 0.10 t and less than or equal to 0.18 t, greater than or equal to 0.11 t and less than or equal to 0.18 t, greater than or equal to 0.12 t and less than or equal to 0.18 t, greater than or equal to 0.13 t and less than or equal to 0.18 t, greater than or equal to 0.14 t and less than or equal to 0.18 t, greater than or equal to 0.15 t and less than or equal to 0.18 t, greater than or equal to 0.16 t and less than or equal to 0.18 t, greater than or equal to 0.17 t and less than or equal to 0.18 t, greater than or equal to 0.05 t and less than or equal to 0.17 t, greater than or equal to 0.06 t and less than or equal to 0.17 t, greater than or equal to 0.07 t and less than or equal to 0.17 t, greater than or equal to 0.08 t and less than or equal to 0.17 t, greater than or equal to 0.09 t and less than or equal to 0.17 t, greater than or equal to 0.10 t and less than or equal to 0.17 t, greater than or equal to 0.11 t and less than or equal to 0.17 t, greater than or equal to 0.12 t and less than or equal to 0.17 t, greater than or equal to 0.13 t and less than or equal to 0.17 t, greater than or equal to 0.14 t and less than or equal to 0.17 t, greater than or equal to 0.15 t and less than or equal to 0.17 t, greater than or equal to 0.16 t and less than or equal to 0.17 t, greater than or equal to 0.05 t and less than or equal to 0.16 t, greater than or equal to 0.06 t and less than or equal to 0.16 t, greater than or equal to 0.07 t and less than or equal to 0.16 t, greater than or equal to 0.08 t and less than or equal to 0.16 t, greater than or equal to 0.09 t and less than or equal to 0.16 t, greater than or equal to 0.10 t and less than or equal to 0.16 t, greater than or equal to 0.11 t and less than or equal to 0.16 t, greater than or equal to 0.12 t and less than or equal to 0.16 t, greater than or equal to 0.13 t and less than or equal to 0.16 t, greater than or equal to 0.14 t and less than or equal to 0.16 t, or greater than or equal to 0.15 t and less than or equal to 0.16 t, where “t” it the thickness as defined herein.

Still referring to FIG. 2 and as noted herein, there is also a central tension region 110 having a central tension (CT) between DOC and DOC′. Accordingly, stress transitions from compressive stress to tensile stress at DOC and DOC′, which are described hereinabove, measured from a surface toward a centerline of the strengthened glass-ceramic article.

In embodiments, the glass-ceramic articles may have a surface compressive stress (CS) of greater than or equal to 125 MPa and less than or equal to 550 MPa, greater than or equal to 150 MPa and less than or equal to 550 MPa, greater than or equal to 175 MPa and less than or equal to 550 MPa, greater than or equal to 200 MPa and less than or equal to 550 MPa, such as greater than or equal to 225 MPa and less than or equal to 550 MPa, greater than or equal to 250 MPa and less than or equal to 550 MPa, greater than or equal to 275 MPa and less than or equal to 550 MPa, greater than or equal to 300 MPa and less than or equal to 550 MPa, greater than or equal to 325 MPa and less than or equal to 550 MPa, greater than or equal to 350 MPa and less than or equal to 550 MPa, greater than or equal to 375 MPa and less than or equal to 550 MPa, greater than or equal to 400 MPa and less than or equal to 550 MPa, greater than or equal to 425 MPa and less than or equal to 550 MPa, greater than or equal to 450 MPa and less than or equal to 550 MPa, greater than or equal to 475 MPa and less than or equal to 550 MPa, greater than or equal to 500 MPa and less than or equal to 550 MPa, greater than or equal to 525 MPa and less than or equal to 550 MPa, greater than or equal to 125 MPa and less than or equal to 500 MPa, greater than or equal to 150 MPa and less than or equal to 500 MPa, greater than or equal to 175 MPa and less than or equal to 500 MPa, greater than or equal to 200 MPa and less than or equal to 500 MPa, such as greater than or equal to 225 MPa and less than or equal to 500 MPa, greater than or equal to 250 MPa and less than or equal to 500 MPa, greater than or equal to 275 MPa and less than or equal to 500 MPa, greater than or equal to 300 MPa and less than or equal to 500 MPa, greater than or equal to 325 MPa and less than or equal to 500 MPa, greater than or equal to 350 MPa and less than or equal to 500 MPa, greater than or equal to 375 MPa and less than or equal to 500 MPa, greater than or equal to 400 MPa and less than or equal to 500 MPa, greater than or equal to 425 MPa and less than or equal to 500 MPa, greater than or equal to 450 MPa and less than or equal to 500 MPa, greater than or equal to 475 MPa and less than or equal to 500 MPa, greater than or equal to 125 MPa and less than or equal to 475 MPa, greater than or equal to 150 MPa and less than or equal to 475 MPa, greater than or equal to 175 MPa and less than or equal to 475 MPa, greater than or equal to 200 MPa and less than or equal to 475 MPa, such as greater than or equal to 225 MPa and less than or equal to 475 MPa, greater than or equal to 250 MPa and less than or equal to 475 MPa, greater than or equal to 275 MPa and less than or equal to 475 MPa, greater than or equal to 300 MPa and less than or equal to 475 MPa, greater than or equal to 325 MPa and less than or equal to 475 MPa, greater than or equal to 350 MPa and less than or equal to 475 MPa, greater than or equal to 375 MPa and less than or equal to 475 MPa, greater than or equal to 400 MPa and less than or equal to 475 MPa, greater than or equal to 425 MPa and less than or equal to 475 MPa, greater than or equal to 450 MPa and less than or equal to 475 MPa, greater than or equal to 125 MPa and less than or equal to 450 MPa, greater than or equal to 150 MPa and less than or equal to 450 MPa, greater than or equal to 175 MPa and less than or equal to 450 MPa, greater than or equal to 200 MPa and less than or equal to 450 MPa, such as greater than or equal to 225 MPa and less than or equal to 450 MPa, greater than or equal to 250 MPa and less than or equal to 450 MPa, greater than or equal to 275 MPa and less than or equal to 450 MPa, greater than or equal to 300 MPa and less than or equal to 450 MPa, greater than or equal to 325 MPa and less than or equal to 450 MPa, greater than or equal to 350 MPa and less than or equal to 450 MPa, greater than or equal to 375 MPa and less than or equal to 450 MPa, greater than or equal to 400 MPa and less than or equal to 450 MPa, greater than or equal to 425 MPa and less than or equal to 450 MPa, greater than or equal to 125 MPa and less than or equal to 425 MPa, greater than or equal to 150 MPa and less than or equal to 425 MPa, greater than or equal to 175 MPa and less than or equal to 425 MPa, greater than or equal to 200 MPa and less than or equal to 425 MPa, such as greater than or equal to 225 MPa and less than or equal to 425 MPa, greater than or equal to 250 MPa and less than or equal to 425 MPa, greater than or equal to 275 MPa and less than or equal to 425 MPa, greater than or equal to 300 MPa and less than or equal to 425 MPa, greater than or equal to 325 MPa and less than or equal to 425 MPa, greater than or equal to 350 MPa and less than or equal to 425 MPa, greater than or equal to 375 MPa and less than or equal to 425 MPa, greater than or equal to 400 MPa and less than or equal to 425 MPa, greater than or equal to 125 MPa and less than or equal to 400 MPa, greater than or equal to 150 MPa and less than or equal to 400 MPa, greater than or equal to 175 MPa and less than or equal to 400 MPa, greater than or equal to 200 MPa and less than or equal to 400 MPa, such as greater than or equal to 225 MPa and less than or equal to 400 MPa, greater than or equal to 250 MPa and less than or equal to 400 MPa, greater than or equal to 275 MPa and less than or equal to 400 MPa, greater than or equal to 300 MPa and less than or equal to 400 MPa, greater than or equal to 325 MPa and less than or equal to 400 MPa, greater than or equal to 350 MPa and less than or equal to 400 MPa, greater than or equal to 375 MPa and less than or equal to 400 MPa, greater than or equal to 125 MPa and less than or equal to 375 MPa, greater than or equal to 150 MPa and less than or equal to 375 MPa, greater than or equal to 175 MPa and less than or equal to 375 MPa, greater than or equal to 200 MPa and less than or equal to 375 MPa, greater than or equal to 225 MPa and less than or equal to 375 MPa, greater than or equal to 250 MPa and less than or equal to 375 MPa, greater than or equal to 275 MPa and less than or equal to 375 MPa, greater than or equal to 300 MPa and less than or equal to 375 MPa, greater than or equal to 325 MPa and less than or equal to 375 MPa, greater than or equal to 350 MPa and less than or equal to 375 MPa, greater than or equal to 125 MPa and less than or equal to 350 MPa, greater than or equal to 150 MPa and less than or equal to 350 MPa, greater than or equal to 175 MPa and less than or equal to 350 MPa, greater than or equal to 200 MPa and less than or equal to 350 MPa, greater than or equal to 225 MPa and less than or equal to 350 MPa, greater than or equal to 250 MPa and less than or equal to 350 MPa, greater than or equal to 275 MPa and less than or equal to 350 MPa, greater than or equal to 300 MPa and less than or equal to 350 MPa, greater than or equal to 325 MPa and less than or equal to 350 MPa, greater than or equal to 125 MPa and less than or equal to 325 MPa, greater than or equal to 150 MPa and less than or equal to 325 MPa, greater than or equal to 175 MPa and less than or equal to 325 MPa, greater than or equal to 200 MPa and less than or equal to 325 MPa, greater than or equal to 225 MPa and less than or equal to 325 MPa, greater than or equal to 250 MPa and less than or equal to 325 MPa, greater than or equal to 275 MPa and less than or equal to 325 MPa, greater than or equal to 300 MPa and less than or equal to 325 MPa, greater than or equal to 125 MPa and less than or equal to 300 MPa, greater than or equal to 150 MPa and less than or equal to 300 MPa, greater than or equal to 175 MPa and less than or equal to 300 MPa, greater than or equal to 200 MPa and less than or equal to 300 MPa, greater than or equal to 225 MPa and less than or equal to 300 MPa, greater than or equal to 250 MPa and less than or equal to 300 MPa, greater than or equal to 275 MPa and less than or equal to 300 MPa, greater than or equal to 125 MPa and less than or equal to 275 MPa, greater than or equal to 150 MPa and less than or equal to 275 MPa, greater than or equal to 175 MPa and less than or equal to 275 MPa, greater than or equal to 200 MPa and less than or equal to 275 MPa, greater than or equal to 225 MPa and less than or equal to 275 MPa, greater than or equal to 250 MPa and less than or equal to 275 MPa, greater than or equal to 200 MPa and less than or equal to 275 MPa, greater than or equal to 225 MPa and less than or equal to 275 MPa, greater than or equal to 125 MPa and less than or equal to 225 MPa, greater than or equal to 150 MPa and less than or equal to 225 MPa, greater than or equal to 175 MPa and less than or equal to 225 MPa, or greater than or equal to 200 MPa and less than or equal to 225 MPa. It should be understood that the above ranges include all subranges within the explicitly disclosed ranges.

In embodiments, the maximum central tension (CT) is greater than or equal to 100 MPa, greater than or equal to 110 MPa, greater than or equal to 120 MPa, greater than or equal to 130 MPa, greater than or equal to 140 MPa, greater than or equal to 150 MPa, or even greater than or equal to 160 MPa. In embodiments, the maximum central tension is greater than or equal to 100 MPa and less than or equal to 170 MPa, greater than or equal to 110 MPa and less than or equal to 170 MPa, greater than or equal to 120 MPa and less than or equal to 170 MPa, greater than or equal to 130 MPa and less than or equal to 170 MPa, greater than or equal to 140 MPa and less than or equal to 170 MPa, greater than or equal to 150 MPa and less than or equal to 170 MPa, greater than or equal to 160 MPa and less than or equal to 170 MPa, greater than or equal to 100 MPa and less than or equal to 160 MPa, greater than or equal to 110 MPa and less than or equal to 160 MPa, greater than or equal to 120 MPa and less than or equal to 160 MPa, greater than or equal to 130 MPa and less than or equal to 160 MPa, greater than or equal to 140 MPa and less than or equal to 160 MPa, greater than or equal to 150 MPa and less than or equal to 160 MPa, greater than or equal to 100 MPa and less than or equal to 150 MPa, greater than or equal to 110 MPa and less than or equal to 150 MPa, greater than or equal to 120 MPa and less than or equal to 150 MPa, greater than or equal to 130 MPa and less than or equal to 150 MPa, greater than or equal to 140 MPa and less than or equal to 150 MPa, greater than or equal to 100 MPa and less than or equal to 140 MPa, greater than or equal to 110 MPa and less than or equal to 140 MPa, greater than or equal to 120 MPa and less than or equal to 140 MPa, greater than or equal to 130 MPa and less than or equal to 140 MPa, greater than or equal to 100 MPa and less than or equal to 130 MPa, greater than or equal to 110 MPa and less than or equal to 130 MPa, greater than or equal to 120 MPa and less than or equal to 130 MPa, greater than or equal to 100 MPa and less than or equal to 120 MPa, greater than or equal to 110 MPa and less than or equal to 120 MPa, or even greater than or equal to 100 MPa and less than or equal to 110 MPa, It should be understood that the above ranges include all subranges within the explicitly disclosed ranges.

According to embodiments, the stress in the glass-ceramic article transitions from compressive stress to tensile stress at a depth measured from a surface of the glass-ceramic article toward the centerline of the glass-ceramic article that is greater than or equal to 0.05 t and less than or equal to 0.30 t, greater than or equal to 0.06 t and less than or equal to 0.30 t, greater than or equal to 0.07 t and less than or equal to 0.30 t, greater than or equal to 0.08 t and less than or equal to 0.30 t, greater than or equal to 0.09 t and less than or equal to 0.30 t, greater than or equal to 0.10 t and less than or equal to 0.30 t, greater than or equal to 0.11 t and less than or equal to 0.30 t, greater than or equal to 0.12 t and less than or equal to 0.30 t, greater than or equal to 0.13 t and less than or equal to 0.30 t, greater than or equal to 0.14 t and less than or equal to 0.30 t, greater than or equal to 0.15 t and less than or equal to 0.30 t, greater than or equal to 0.16 t and less than or equal to 0.30 t, greater than or equal to 0.17 t and less than or equal to 0.30 t, greater than or equal to 0.18 t and less than or equal to 0.30 t, greater than or equal to 0.19 t and less than or equal to 0.30 t, greater than or equal to 0.20 t and less than or equal to 0.30 t, greater than or equal to 0.21 t and less than or equal to 0.30 t, greater than or equal to 0.22 t and less than or equal to 0.30 t, greater than or equal to 0.23 t and less than or equal to 0.30 t, greater than or equal to 0.24 t and less than or equal to 0.30 t, greater than or equal to 0.05 t and less than or equal to 0.25 t, greater than or equal to 0.06 t and less than or equal to 0.25 t, greater than or equal to 0.07 t and less than or equal to 0.25 t, greater than or equal to 0.08 t and less than or equal to 0.25 t, greater than or equal to 0.09 t and less than or equal to 0.25 t, greater than or equal to 0.10 t and less than or equal to 0.25 t, greater than or equal to 0.11 t and less than or equal to 0.25 t, greater than or equal to 0.12 t and less than or equal to 0.25 t, greater than or equal to 0.13 t and less than or equal to 0.25 t, greater than or equal to 0.14 t and less than or equal to 0.25 t, greater than or equal to 0.15 t and less than or equal to 0.25 t, greater than or equal to 0.16 t and less than or equal to 0.25 t, greater than or equal to 0.17 t and less than or equal to 0.25 t, greater than or equal to 0.18 t and less than or equal to 0.25 t, greater than or equal to 0.19 t and less than or equal to 0.25 t, greater than or equal to 0.20 t and less than or equal to 0.25 t, greater than or equal to 0.21 t and less than or equal to 0.25 t, greater than or equal to 0.22 t and less than or equal to 0.25 t, greater than or equal to 0.23 t and less than or equal to 0.25 t, greater than or equal to 0.24 t and less than or equal to 0.25 t, greater than or equal to 0.05 t and less than or equal to 0.24 t, greater than or equal to 0.06 t and less than or equal to 0.24 t, greater than or equal to 0.07 t and less than or equal to 0.24 t, greater than or equal to 0.08 t and less than or equal to 0.24 t, greater than or equal to 0.09 t and less than or equal to 0.24 t, greater than or equal to 0.10 t and less than or equal to 0.24 t, greater than or equal to 0.11 t and less than or equal to 0.24 t, greater than or equal to 0.12 t and less than or equal to 0.24 t, greater than or equal to 0.13 t and less than or equal to 0.24 t, greater than or equal to 0.14 t and less than or equal to 0.24 t, greater than or equal to 0.15 t and less than or equal to 0.24 t, greater than or equal to 0.16 t and less than or equal to 0.24 t, greater than or equal to 0.17 and less than or equal to 0.24 t, greater than or equal to 0.18 t and less than or equal to 0.24 t, greater than or equal to 0.19 t and less than or equal to 0.24 t, greater than or equal to 0.20 t and less than or equal to 0.24 t, greater than or equal to 0.21 t and less than or equal to 0.24 t, greater than or equal to 0.22 t and less than or equal to 0.24 t, greater than or equal to 0.23 t and less than or equal to 0.24 t, greater than or equal to 0.05 t and less than or equal to 0.23 t, greater than or equal to 0.06 t and less than or equal to 0.23 t, greater than or equal to 0.07 t and less than or equal to 0.23 t, greater than or equal to 0.08 t and less than or equal to 0.23 t, greater than or equal to 0.09 t and less than or equal to 0.23 t, greater than or equal to 0.10 t and less than or equal to 0.23 t, greater than or equal to 0.11 t and less than or equal to 0.23 t, greater than or equal to 0.12 t and less than or equal to 0.23 t, greater than or equal to 0.13 t and less than or equal to 0.23 t, greater than or equal to 0.14 t and less than or equal to 0.23 t, greater than or equal to 0.15 t and less than or equal to 0.23 t, greater than or equal to 0.16 t and less than or equal to 0.23 t, greater than or equal to 0.17 t and less than or equal to 0.23 t, greater than or equal to 0.18 t and less than or equal to 0.23 t, greater than or equal to 0.19 t and less than or equal to 0.23 t, greater than or equal to 0.20 t and less than or equal to 0.23 t, greater than or equal to 0.21 t and less than or equal to 0.23 t, greater than or equal to 0.22 t and less than or equal to 0.23 t, greater than or equal to 0.05 t and less than or equal to 0.22 t, greater than or equal to 0.06 t and less than or equal to 0.22 t, greater than or equal to 0.07 t and less than or equal to 0.22 t, greater than or equal to 0.08 t and less than or equal to 0.22 t, greater than or equal to 0.09 t and less than or equal to 0.22 t, greater than or equal to 0.10 t and less than or equal to 0.22 t, greater than or equal to 0.11 t and less than or equal to 0.22 t, greater than or equal to 0.12 t and less than or equal to 0.22 t, greater than or equal to 0.13 t and less than or equal to 0.22 t, greater than or equal to 0.14 t and less than or equal to 0.22 t, greater than or equal to 0.15 t and less than or equal to 0.22 t, greater than or equal to 0.16 t and less than or equal to 0.22 t, greater than or equal to 0.17 t and less than or equal to 0.22 t, greater than or equal to 0.18 t and less than or equal to 0.22 t, greater than or equal to 0.19 t and less than or equal to 0.22 t, greater than or equal to 0.20 t and less than or equal to 0.22 t, greater than or equal to 0.21 t and less than or equal to 0.22 t, greater than or equal to 0.05 t and less than or equal to 0.21 t, greater than or equal to 0.06 t and less than or equal to 0.21 t, greater than or equal to 0.07 t and less than or equal to 0.21 t, greater than or equal to 0.08 t and less than or equal to 0.21 t, greater than or equal to 0.09 t and less than or equal to 0.21 t, greater than or equal to 0.10 t and less than or equal to 0.21 t, greater than or equal to 0.11 t and less than or equal to 0.21 t, greater than or equal to 0.12 t and less than or equal to 0.21 t, greater than or equal to 0.13 t and less than or equal to 0.21 t, greater than or equal to 0.14 t and less than or equal to 0.21 t, greater than or equal to 0.15 t and less than or equal to 0.21 t, greater than or equal to 0.16 t and less than or equal to 0.21 t, greater than or equal to 0.17 t and less than or equal to 0.21 t, greater than or equal to 0.18 t and less than or equal to 0.21 t, greater than or equal to 0.19 t and less than or equal to 0.21 t, greater than or equal to 0.20 t and less than or equal to 0.21 t, greater than or equal to 0.05 t and less than or equal to 0.20 t, greater than or equal to 0.06 t and less than or equal to 0.20 t, greater than or equal to 0.07 t and less than or equal to 0.20 t, greater than or equal to 0.08 t and less than or equal to 0.20 t, greater than or equal to 0.09 t and less than or equal to 0.20 t, greater than or equal to 0.10 t and less than or equal to 0.20 t, greater than or equal to 0.11 t and less than or equal to 0.20 t, greater than or equal to 0.12 t and less than or equal to 0.20 t, greater than or equal to 0.13 t and less than or equal to 0.20 t, greater than or equal to 0.14 t and less than or equal to 0.20 t, greater than or equal to 0.15 t and less than or equal to 0.20 t, greater than or equal to 0.16 t and less than or equal to 0.20 t, greater than or equal to 0.17 t and less than or equal to 0.20 t, greater than or equal to 0.18 t and less than or equal to 0.20 t, greater than or equal to 0.19 t and less than or equal to 0.20 t, greater than or equal to 0.05 t and less than or equal to 0.19 t, greater than or equal to 0.06 t and less than or equal to 0.19 t, greater than or equal to 0.07 t and less than or equal to 0.19 t, greater than or equal to 0.08 t and less than or equal to 0.19 t, greater than or equal to 0.09 t and less than or equal to 0.19 t, greater than or equal to 0.10 t and less than or equal to 0.19 t, greater than or equal to 0.11 t and less than or equal to 0.19 t, greater than or equal to 0.12 t and less than or equal to 0.19 t, greater than or equal to 0.13 t and less than or equal to 0.19 t, greater than or equal to 0.14 t and less than or equal to 0.19 t, greater than or equal to 0.15 t and less than or equal to 0.19 t, greater than or equal to 0.16 t and less than or equal to 0.19 t, greater than or equal to 0.17 t and less than or equal to 0.19 t, greater than or equal to 0.18 t and less than or equal to 0.19 t, greater than or equal to 0.05 t and less than or equal to 0.18 t, greater than or equal to 0.06 t and less than or equal to 0.18 t, greater than or equal to 0.07 t and less than or equal to 0.18 t, greater than or equal to 0.08 t and less than or equal to 0.18 t, greater than or equal to 0.09 t and less than or equal to 0.18 t, greater than or equal to 0.10 t and less than or equal to 0.18 t, greater than or equal to 0.11 t and less than or equal to 0.18 t, greater than or equal to 0.12 t and less than or equal to 0.18 t, greater than or equal to 0.13 t and less than or equal to 0.18 t, greater than or equal to 0.14 t and less than or equal to 0.18 t, greater than or equal to 0.15 t and less than or equal to 0.18 t, greater than or equal to 0.16 t and less than or equal to 0.18 t, greater than or equal to 0.17 t and less than or equal to 0.18 t, greater than or equal to 0.05 t and less than or equal to 0.17 t, greater than or equal to 0.06 t and less than or equal to 0.17 t, greater than or equal to 0.07 t and less than or equal to 0.17 t, greater than or equal to 0.08 t and less than or equal to 0.17 t, greater than or equal to 0.09 t and less than or equal to 0.17 t, greater than or equal to 0.10 t and less than or equal to 0.17 t, greater than or equal to 0.11 t and less than or equal to 0.17 t, greater than or equal to 0.12 t and less than or equal to 0.17 t, greater than or equal to 0.13 t and less than or equal to 0.17 t, greater than or equal to 0.14 t and less than or equal to 0.17 t, greater than or equal to 0.15 t and less than or equal to 0.17 t, greater than or equal to 0.16 t and less than or equal to 0.17 t, greater than or equal to 0.05 t and less than or equal to 0.16 t, greater than or equal to 0.06 t and less than or equal to 0.16 t, greater than or equal to 0.07 t and less than or equal to 0.16 t, greater than or equal to 0.08 t and less than or equal to 0.16 t, greater than or equal to 0.09 t and less than or equal to 0.16 t, greater than or equal to 0.10 t and less than or equal to 0.16 t, greater than or equal to 0.11 t and less than or equal to 0.16 t, greater than or equal to 0.12 t and less than or equal to 0.16 t, greater than or equal to 0.13 t and less than or equal to 0.16 t, greater than or equal to 0.14 t and less than or equal to 0.16 t, or greater than or equal to 0.15 t and less than or equal to 0.16 t. It should be understood that the above ranges include all subranges within the explicitly disclosed ranges.

In embodiments, the glass-ceramic article has a thickness t that is greater than or equal to 0.1 mm and less than or equal to 2.5 mm, greater than or equal to 0.3 mm and less than or equal to 2.5 mm, greater than or equal to 0.5 mm and less than or equal to 2.5 mm, greater than or equal to 0.8 mm and less than or equal to 2.5 mm, greater than or equal to 1.0 mm and less than or equal to 2.5 mm, greater than or equal to 1.3 mm and less than or equal to 2.5 mm, greater than or equal to 1.5 mm and less than or equal to 2.5 mm, greater than or equal to 1.8 mm and less than or equal to 2.5 mm, greater than or equal to 1.9 mm and less than or equal to 2.5 mm, greater than or equal to 2.0 mm and less than or equal to 2.5 mm, greater than or equal to 2.1 mm and less than or equal to 2.5 mm, greater than or equal to 2.2 mm and less than or equal to 2.5 mm, greater than or equal to 2.3 mm and less than or equal to 2.5 mm, greater than or equal to 2.4 mm and less than or equal to 2.5 mm, greater than or equal to 0.1 mm and less than or equal to 2.0 mm, greater than or equal to 0.3 mm and less than or equal to 2.0 mm, greater than or equal to 0.5 mm and less than or equal to 2.0 mm, greater than or equal to 0.8 mm and less than or equal to 2.0 mm, greater than or equal to 1.0 mm and less than or equal to 2.0 mm, greater than or equal to 1.3 mm and less than or equal to 2.0 mm, greater than or equal to 1.5 mm and less than or equal to 2.0 mm, greater than or equal to 1.8 mm and less than or equal to 2.0 mm, greater than or equal to 0.1 mm and less than or equal to 1.8 mm, greater than or equal to 0.3 mm and less than or equal to 1.8 mm, greater than or equal to 0.5 mm and less than or equal to 1.8 mm, greater than or equal to 0.8 mm and less than or equal to 1.8 mm, greater than or equal to 1.0 mm and less than or equal to 1.8 mm, greater than or equal to 1.3 mm and less than or equal to 1.8 mm, greater than or equal to 1.5 mm and less than or equal to 1.8 mm, greater than or equal to 0.1 mm and less than or equal to 1.5 mm, greater than or equal to 0.3 mm and less than or equal to 1.5 mm, greater than or equal to 0.5 mm and less than or equal to 1.5 mm, greater than or equal to 0.8 mm and less than or equal to 1.5 mm, greater than or equal to 1.0 mm and less than or equal to 1.5 mm, greater than or equal to 1.3 mm and less than or equal to 1.5 mm, greater than or equal to 0.1 mm and less than or equal to 1.3 mm, greater than or equal to 0.3 mm and less than or equal to 1.3 mm, greater than or equal to 0.5 mm and less than or equal to 1.3 mm, greater than or equal to 0.8 mm and less than or equal to 1.3 mm, greater than or equal to 1.0 mm and less than or equal to 1.3 mm, greater than or equal to 0.1 mm and less than or equal to 1.0 mm, greater than or equal to 0.3 mm and less than or equal to 1.0 mm, greater than or equal to 0.5 mm and less than or equal to 1.0 mm, greater than or equal to 0.8 mm and less than or equal to 1.0 mm, greater than or equal to 0.1 mm and less than or equal to 0.8 mm, greater than or equal to 0.3 mm and less than or equal to 0.8 mm, greater than or equal to 0.5 mm and less than or equal to 0.8 mm, greater than or equal to 0.1 mm and less than or equal to 0.5 mm, greater than or equal to 0.3 mm and less than or equal to 0.5 mm, or greater than or equal to 0.1 mm and less than or equal to 0.3 mm. It should be understood that the above ranges include all subranges within the explicitly disclosed ranges.

In embodiments, the colored glass-ceramic articles appear red in color and may have a transmittance color coordinate in the CIELAB color space following ceramming, as measured at an article thickness of 0.55 to 2.4 mm for a CIE D65 illuminant under SCI UVC conditions and a 10° standard observer angle, of: L* greater than or equal to 0 and less than or equal to 100; a* greater than or equal to −18 and less than or equal to 65; and b* greater than or equal to −4.5 and less than or equal to 60. In embodiments the colored glass-ceramic articles appear red in color and may have a transmittance color coordinate in the CIELAB color space, as measured at an article thickness of 0.55 mm for a CIE D65 illuminant under SCI UVC conditions and a 10° standard observer angle, of: L* greater than or equal to 2.5 and less than or equal to 96; a* greater than or equal to 0.30 and less than or equal to 62; and b* greater than or equal to −1.3 and less than or equal to 55. As noted herein, the red color of the glass-ceramics is a result of the reduction of copper (I) in the precursor glass during ceramming resulting in the precipitation of copper metal nanoparticles in the glass-ceramic.

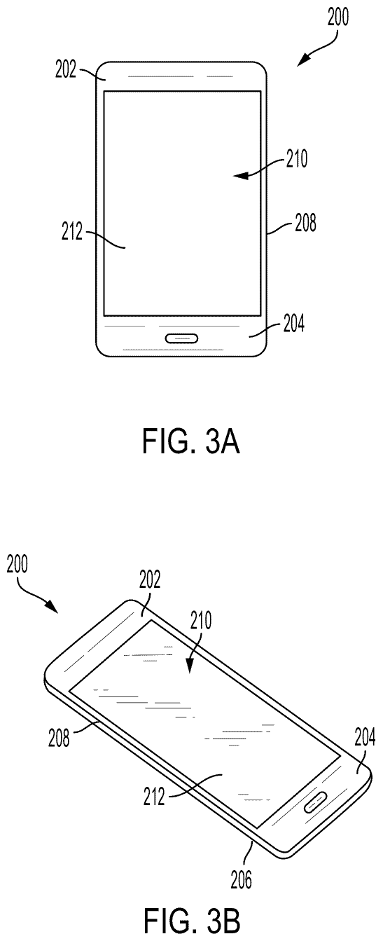

The precursor glass and glass-ceramic articles disclosed herein may be incorporated into another article (e.g., consumer electronics, including mobile phones, tablets, computers, navigation systems, wearable devices (e.g., watches) and the like), architectural articles, transportation articles (e.g., automotive, trains, aircraft, sea craft, etc.), appliance articles, or any article. An exemplary article incorporating any of the strengthened glass-ceramic articles disclosed herein is shown in FIGS. 3A and 3B.

Specifically, FIGS. 3A and 3B show a consumer electronic device 200 including a housing 202 having front 204, back 206, and side surfaces 208; electrical components (not shown) that are at least partially inside or entirely within the housing and including at least a controller, a memory, and a display 210 at or adjacent to the front surface of the housing; and a cover substrate 212 at or over the front surface of the housing such that it is over the display 210. In some embodiments, at least a portion of the housing 202 (such as the back 206) may include any of the strengthened glass-ceramics disclosed herein.

Additionally, the precursor glasses disclosed herein can be cerammed into other shapes (i.e., other than a plate or sheet) with minimal deformation, readily machined to precision shapes, cut, drilled, chamfered, tapped, polished to high luster with conventional ceramic machining tooling and even exhibit various degrees of translucency depending on composition and heat treatment. These properties make the glass-ceramics useful for a broad number of applications in addition to those identified herein, including, without limitation, countertops and other surfaces, appliance doors and exteriors, floor tiles, wall panels, ceiling tiles, white boards, materials storage containers (hollowware) such as beverage bottles, food sales and storage vessels, machine parts requiring light weight, good wear resistance and precise dimensions. The glass-ceramics can be formed in three-dimensional articles using various methods.

Accordingly, various embodiments described herein may be employed to produce glass-ceramic articles having the desired red color. Such glass-ceramic articles may be particularly well suited for use in portable electronic devices.

### EXAMPLES

The embodiments described herein will be further clarified by the following examples.

Precursor glasses having the compositions and thicknesses listed in Tables 1-3 were cerammed according to the ceramming cycles indicated in Tables 1-3. Thereafter, CIE LAB color coordinates were obtained for CIE illuminant D65 under SCI UVC conditions and a 10 degree observer angle. L*, a*, and b* values are reported in Tables 1-3 for the measured samples. A qualitative (visual) assessment of each of the glass-ceramics was also made and each of the glass-ceramics exhibited a red color.

TABLE 1

| Oxide | | | | | | | |
|---|---|---|---|---|---|---|---|
| (wt %) | Ex. 1 | Ex. 2 | Ex. 3 | Ex. 4 | Ex. 5 | Ex. 6 | Ex. 7 |
| SiO₂ | 74.214 | 73.589 | 73.796 | 72.643 | 71.516 | 74.693 | 74.704 |
| Al₂O₃ | 7.581 | 7.580 | 7.573 | 7.551 | 7.110 | 7.095 | 7.571 |
| Li₂O | 11.167 | 11.181 | 11.170 | 11.171 | 11.577 | 11.170 | 11.227 |
| Na₂O | 0.000 | 0.000 | 0.000 | 0.000 | 0.000 | 0.000 | 0.000 |
| K₂O | 0.011 | 0.012 | 0.011 | 0.011 | 0.012 | 0.011 | 0.000 |
| CaO | 0.020 | 0.670 | 0.021 | 0.024 | 0.674 | 0.020 | 0.021 |
| MgO | 0.012 | 0.024 | 0.012 | 0.010 | 0.025 | 0.012 | 0.011 |
| P₂O₅ | 2.062 | 2.055 | 2.461 | 2.065 | 2.473 | 2.063 | 2.093 |
| ZrO₂ | 4.321 | 4.255 | 4.289 | 5.873 | 5.988 | 4.325 | 3.404 |
| SnO₂ | 0.409 | 0.443 | 0.463 | 0.458 | 0.428 | 0.414 | 0.444 |
| Fe₂O₃ | 0.011 | 0.013 | 0.012 | 0.013 | 0.013 | 0.011 | 0.012 |
| Cu₂O | 0.192 | 0.179 | 0.192 | 0.183 | 0.184 | 0.187 | 0.515 |
| Ceram | 580/5/ | 580/5/ | 580/5/ | 580/5/ | 580/5/ | 580/5/ | 580/5/ |
| Cycle | 700/0.5 | 700/0.5 | 700/0.5 | 700/0.5 | 700/0.5 | 700/0.5 | 700/0.5 |
| (Nucleation | | | | | | | |
| Temp (° C.)/ | | | | | | | |
| Nucleation | | | | | | | |
| Time (hrs.)/ | | | | | | | |
| Growth | | | | | | | |
| Temp (° C.)/ | | | | | | | |
| Growth | | | | | | | |
| Time (hrs.)) | | | | | | | |
| Thickness | 0.513 | 0.576 | 0.589 | 0.569 | 0.549 | 0.551 | 5.094 |
| (mm) | | | | | | | |
| D65 - L* | 63.84 | 39.77 | 76.71 | 84.27 | 71.71 | 56.91 | 96.46 |
| D65 - a* | 25.06 | 54.55 | 15.36 | 6.94 | 17.34 | 30.38 | −0.86 |
| D65 - b* | 12.68 | 39.55 | 8.97 | 6.05 | 8.28 | 15.07 | −0.31 |

TABLE 2

| Oxide | | | | | | |
|---|---|---|---|---|---|---|
| (wt %) | Ex. 8 | Ex. 9 | Ex. 10 | Ex. 11 | Ex. 12 | Ex. 13 |
| SiO₂ | 73.593 | 73.590 | 73.602 | 73.208 | 73.190 | 73.183 |
| Al₂O₃ | 7.574 | 7.582 | 7.579 | 7.444 | 7.393 | 7.396 |
| Li₂O | 11.176 | 11.174 | 11.168 | 11.180 | 11.195 | 11.184 |
| Na₂O | 0.000 | 0.000 | 0.000 | 0.000 | 0.000 | 0.000 |
| K₂O | 0.011 | 0.011 | 0.011 | 0.091 | 0.095 | 0.095 |
| CaO | 0.687 | 0.687 | 0.682 | 0.681 | 0.688 | 0.690 |
| MgO | 0.030 | 0.030 | 0.030 | 0.028 | 0.025 | 0.026 |
| P₂O₅ | 2.066 | 2.065 | 2.064 | 2.168 | 2.211 | 2.219 |
| ZrO₂ | 4.219 | 4.210 | 4.223 | 4.643 | 4.748 | 4.752 |
| SnO₂ | 0.448 | 0.450 | 0.447 | 0.376 | 0.290 | 0.293 |
| Fe₂O₃ | 0.015 | 0.015 | 0.015 | 0.051 | 0.049 | 0.049 |
| Cu₂O | 0.183 | 0.185 | 0.179 | 0.130 | 0.116 | 0.113 |
| Ceram | 585/2.8/ | 585/2.8/ | 585/2.8/ | 585/2.8/ | 585/2.8/ | 585/2.8/ |
| Cycle | 735/1 | 735/1 | 735/1 | 735/1 | 735/1 | 735/1 |
| (Nucleation | | | | | | |
| Temp (° C.)/ | | | | | | |
| Nucleation | | | | | | |
| Time (hrs.)/ | | | | | | |
| Growth | | | | | | |
| Temp (° C.)/ | | | | | | |
| Growth | | | | | | |
| Time (hrs.)) | | | | | | |
| Thickness | 0.532 | 0.519 | 0.537 | 0.551 | 0.552 | 0.55 |
| (mm) | | | | | | |
| D65 - L* | 18.33 | 15.27 | 14.95 | 33.38 | 32.9 | 33.18 |
| D65 - a* | 49.13 | 45.54 | 45.16 | 61.46 | 61.13 | 61.08 |
| D65 - b* | 31.57 | 26.29 | 25.74 | 55.55 | 54.91 | 55.08 |

TABLE 3

| Oxide (wt %) | Ex. 14 | Ex. 15 | Ex. 16 | Ex. 17 | Ex. 18 |
|---|---|---|---|---|---|
| SiO₂ | 73.501 | 73.575 | 73.259 | 73.355 | 73.67 |
| Al₂O₃ | 7.389 | 7.353 | 7.374 | 7.390 | 7.37 |
| Li₂O | 11.203 | 11.193 | 11.180 | 11.190 | 11.02 |
| Na₂O | 0.000 | 0.000 | 0.000 | 0.000 | 0 |
| K₂O | 0.007 | 0.007 | 0.021 | 0.007 | 0.008 |
| CaO | 1.015 | 1.012 | 1.008 | 1.648 | 1.004 |
| MgO | 0.010 | 0.009 | 0.015 | 0.015 | 0.01 |
| P₂O₅ | 2.097 | 2.095 | 2.093 | 2.094 | 2.096 |
| ZrO₂ | 4.426 | 4.433 | 4.404 | 3.947 | 4.44 |
| SnO₂ | 0.191 | 0.210 | 0.433 | 0.198 | 0.224 |
| Fe₂O₃ | 0.011 | 0.008 | 0.010 | 0.012 | 0.012 |
| Cu₂O | 0.149 | 0.105 | 0.202 | 0.144 | 0.155 |
| Ceram Cycle | 560/4/2.5/700/0.5 | 590/4/700/0.5 | 590/4/700/0.5 | 590/4/700/0.5 | 590/4/700/0.5 |
| (Nucleation | | | | | |
| Temp (° C.)/ | | | | | |
| Nucleation | | | | | |
| Time (hrs.)/ | | | | | |
| Growth Temp | | | | | |
| (° C.)/Growth | | | | | |
| Time (hrs.)) | | | | | |
| Thickness | 0.545 | 0.503 | 0.503 | 0.575 | 0.55 |
| (mm) | | | | | |
| D65 - L* | 26.49 | 94.68 | 0.02 | 31.33 | |
| D65 - a* | 57.78 | 0.91 | 0.1 | 61.22 | |
| D65 - b* | 45.59 | 1.93 | 0.02 | 53.07 | |

X-ray diffraction (XRD) was conducted on powdered samples of select cerammed examples using a Bruker D4 Endeavor equipped with Cu radiation and a LynxEye detector to determine the phase assemblage of the glass-ceramics. The phase assemblage was determined using the Rietveld method and using Bruker's Topas software package. The results are reported in Tables 4 and 5 below. As indicated, the phase assemblage of the glass-ceramics included petalite and lithium disilicate as the primary crystalline phases.

TABLE 4

| | Ex. 16 | Ex. 17 | Ex. 16 | Ex. 17 |
|---|---|---|---|---|
| Ceram Cycle | 560/4/700/0.5 | 560/4/700/0.5 | 590/4/700/0.5 | 590/4/700/0.5 |
| (Nucleation | | | | |
| Temp (° C.)/ | | | | |
| Nucleation | | | | |
| Time (hrs.)/ | | | | |
| Growth Temp | | | | |
| (° C.)/Growth | | | | |
| Time (hrs.)) | | | | |
| Residual | 14.13 | 14.13 | 15.2 | 15.08 |
| glass (wt %) | | | | |
| Li₂Si₂O₅ | 27.25 | 26.24 | 26.34 | 28.14 |
| (wt %) | | | | |
| Petalite | 52.47 | 53.48 | 49.65 | 48.24 |
| (wt %) | | | | |
| Li₂SiO₃ | 6.16 | 6.16 | 5.98 | 6.23 |
| (wt %) | | | | |
| Cristobalite | 0 | 0 | 0 | 0 |
| (wt %) | | | | |
| Virgilite | 0 | 0 | 2.84 | 2.31 |
| (wt %) | | | | |
| Copper metal | Y | Y | Y | Y |
| nanoparticles | | | | |

TABLE 5

| | Ex. 2 | Ex. 2 | Ex. 2 |
|---|---|---|---|
| Ceram Cycle | 560/5/700/0.5 | 560/4/700/1.0 | 585/3/700/0.75 |
| (Nucleation | | | |
| Temp (° C.)/ | | | |
| Nucleation | | | |
| Time (hrs.)/ | | | |
| Growth Temp | | | |
| (° C.)/Growth | | | |
| Time (hrs.)) | | | |
| Residual glass | 10 | 13 | 12 |
| (wt %) | | | |
| Li₂Si₂O₅ | 40 | 26 | 26 |
| (wt %) | | | |
| Petalite (wt %) | 48 | 53 | 54 |
| Li₂SiO₃ (wt %) | 0 | 7.7 | 7.1 |
| Cristobalite | 0 | 0 | 0 |
| (wt %) | | | |
| Virgilite | 1.3 | 0.2 | 0.7 |
| (wt %) | | | |
| Copper metal | Y | Y | Y |
| nanoparticles | | | |

The glass-ceramics of example 18 were strengthened by ion exchange for ion exchange times ranging from 4 hours to 12 hours and temperatures of 500° C. and 530° C. The ion exchange bath included 40 wt % NaNO₃, 60 wt % KNO₃, 0.12 wt % LiNO₃, and 0.5 wt. % silicic acid. Thereafter, the depth of compression and maximum central tension were measured. The results are presented in Table 6.

TABLE 6

| | | Max Central | Depth of |
|---|---|---|---|
| IOX Temp. | IOX Time | Tension | Compression |
| (° C.) | (hrs.) | (MPa) | (μm) |
| 500 | 6 | 111 | 60.72 |
| 500 | 8 | 124 | 39.67 |
| 500 | 10 | 121 | 108.67 |
| 500 | 12 | 127 | 57.41 |
| 530 | 4 | 134 | 47.59 |
| 530 | 5 | 136 | 32.71 |
| 530 | 6 | 139 | 43.16 |

Glass melts were formed from glass batch materials having the compositions listed in Table 7. The melting and fining conditions were the same for each Example. The glass batch materials of Examples 19-25 included Cu₂O to impart color to the resulting glass-ceramics. The glass batch materials of Example 19 included SnO₂ as a fining agent, but were free of sulfate fining agents. Example 20 was free of both SnO₂ and sulfate fining agents. Examples 21-25 were batched with both SnO₂ and the sulfate fining agent Li₂SO₄, resulting in the presence of SO₃ in the resulting glasses. The amount of the sulfate fining agent in Examples 21-25 was systematically increased from Example 21 to Example 25 while the SnO₂ fining agent was held constant.

TABLE 7

| Oxide | | | | | | | |
|---|---|---|---|---|---|---|---|
| (wt %) | Ex. 19 | Ex. 20 | Ex. 21 | Ex. 22 | Ex. 23 | Ex. 24 | Ex. 25 |
| SiO₂ | 73.74 | 73.74 | 73.74 | 73.74 | 73.74 | 73.74 | 73.74 |
| Al₂O₃ | 7.42 | 7.42 | 7.42 | 7.42 | 7.42 | 7.42 | 7.42 |
| Li₂O | 11.2 | 11.2 | 11.2 | 11.2 | 11.2 | 11.2 | 11.2 |
| Na₂O | 0.000 | 0.000 | 0.000 | 0.000 | 0 | 0 | 0 |
| K₂O | 0.001 | 0.001 | 0.001 | 0.001 | 0.001 | 0.001 | 0.001 |
| CaO | 1.01 | 1.01 | 1.01 | 1.01 | 1.01 | 1.01 | 1.01 |
| MgO | 0 | 0 | 0 | 0 | 0 | 0 | 0 |
| P₂O₅ | 2.103 | 2.103 | 2.103 | 2.103 | 2.103 | 2.103 | 2.103 |
| ZrO₂ | 4.364 | 4.364 | 4.364 | 4.364 | 4.364 | 4.364 | 4.364 |
| SnO₂ | 0.191 | 0 | 0.191 | 0.191 | 0.191 | 0.191 | 0.191 |
| Fe₂O₃ | 0.0135 | 0.0135 | 0.0135 | 0.0135 | 0.0135 | 0.0135 | 0.0135 |
| Cu₂O | 0.146 | 0.146 | 0.146 | 0.146 | 0.146 | 0.146 | 0.146 |
| SO₃ | 0 | 0 | 0.007 | 0.014 | 0.028 | 0.056 | 0.084 |

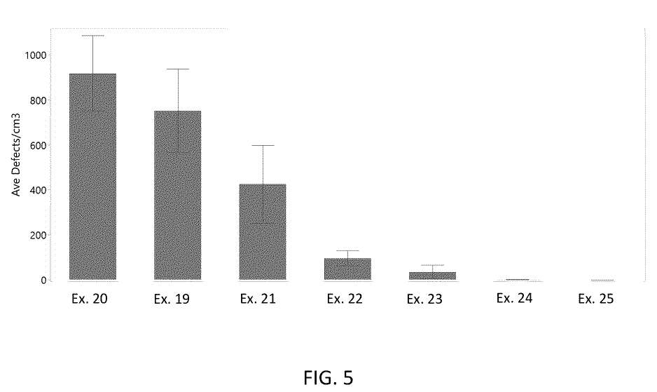

Glass samples were prepared from the melted batch materials and then analyzed under microscope to determine the amount of blister defects in the glass per unit volume (cm³). The results are reported in FIG. 5. As indicated in FIG. 5, Examples 21-25 batched with the sulfate fining agent had significantly fewer blister defects in the glass per unit volume than the samples batched with no fining agent or only SnO₂ as a fining agent, demonstrating the efficacy of sulfate fining agents in reducing blister defects. Moreover, the number of defects per unit volume decreased with increasing concentration of the sulfate fining agent.

To demonstrate the efficacy of sulfate fining agents in precursor glasses and glass-ceramics without the presence of colorants (i.e., transparent, colorless precursor glasses and glass-ceramics), glass melts were formed from glass batch materials having the compositions listed in Table 8. Cu₂O and CuO were both excluded from the glass batch materials. The melting and fining conditions were the same for each Example. The glass batch materials of Example 26 included SnO₂ as a fining agent, but was free of sulfate fining agents. Examples 27-31 were batched with different sulfate fining agents, as indicated in Table 8, resulting in the presence of SO₃ in the resulting glasses.

TABLE 8

| Oxide | | | | | | |
|---|---|---|---|---|---|---|
| (wt %) | Ex. 26 | Ex. 27 | Ex. 28 | Ex. 29 | Ex. 30 | Ex. 31 |
| SiO₂ | 70.74 | 70.74 | 70.71 | 70.69 | 70.69 | 70.57 |
| Al₂O₃ | 5.34 | 5.33 | 5.33 | 5.33 | 5.33 | 5.41 |
| Li₂O | 12.01 | 12.01 | 12.03 | 12 | 12 | 11.98 |
| Na₂O | 0.03 | 0.05 | 0.03 | 0.03 | 0.03 | 0.03 |
| K₂O | 0.02 | 0.02 | 0.02 | 0.08 | 0.02 | 0.02 |
| CaO | 0.72 | 0.72 | 0.72 | 0.72 | 0.77 | 0.72 |
| TiO₂ | 0.01 | 0.01 | 0.01 | 0.01 | 0.01 | 0.01 |
| P₂O₅ | 2.48 | 2.48 | 2.48 | 2.48 | 2.48 | 2.48 |
| ZrO₂ | 8.54 | 8.54 | 8.54 | 8.53 | 8.53 | 8.52 |
| SnO₂ | 0.05 | 0 | 0 | 0 | 0 | 0 |
| Fe₂O₃ | 0.03 | 0.03 | 0.03 | 0.03 | 0.03 | 0.03 |
| Cu₂O | 0 | 0 | 0 | 0 | 0 | 0 |
| Batched | SnO₂ | Na₂SO₄ | Li₂SO₄ | K₂SO₄ | CaSO₄ | Al₂(SO₄)₃ |
| Fining | | | | | | |
| Agent | | | | | | |
| SO₃ | 0 | 0.03 | 0.07 | 0.06 | 0.07 | 0.21 |

Glass samples were prepared from the melted batch materials and then qualitatively observed under microscope. In particular, it was qualitatively observed that Examples 27-31 batched with the sulfate fining agents had significantly fewer blister defects in the glass than the samples batched with only SnO₂ as a fining agent, demonstrating the efficacy of sulfate fining agents in reducing blister defects.

It will be apparent to those skilled in the art that various modifications and variations can be made to the embodiments described herein without departing from the spirit and scope of the claimed subject matter. Thus it is intended that the specification cover the modifications and variations of the various embodiments described herein provided such modification and variations come within the scope of the appended claims and their equivalents.

What is claimed is:

1. A glass-ceramic comprising:
a phase assemblage comprising:
35 wt % to 60 wt % of a petalite crystalline phase;
20 wt % to 60 wt % of a lithium disilicate crystalline phase; and
5 wt % to 20 wt % of a residual amorphous glass phase; and
copper metal nanoparticles dispersed in the residual amorphous glass phase, wherein the glass-ceramic appears red in color and comprises transmittance color coordinates in CIE LAB color space of:
L* greater than or equal to 0 and less than or equal to 100;
a* greater than or equal to −23 and less than or equal to 62; and
b* greater than or equal to −10 and less than or equal to 60.5 at an article thickness of 0.55 mm for a CIE illuminant D65 under SCI UVC conditions and a 10 degree observer angle.

2. The glass-ceramic of claim 1, wherein a size distribution of the copper metal nanoparticles in the glass-ceramic is such that a peak position of a largest dimension of the copper metal nanoparticles is in a range from greater than or equal to 20 nm to less than or equal to 40 nm.

3. The glass-ceramic of claim 1, wherein the glass-ceramic is formed from a precursor glass comprising:
greater than or equal to 65 wt % and less than or equal to 80 wt % SiO₂;
greater than or equal to 1 wt % and less than or equal to 15 wt % Al₂O₃;
greater than or equal to 8 wt % and less than or equal to 15 wt % Li₂O;
greater than or equal to 1 wt % and less than or equal to 4 wt % P₂O₅;
greater than or equal to 2 wt % and less than or equal to 12 wt % ZrO₂;
greater than or equal to 0.01 wt % and less than or equal to 0.6 wt % SnO; and
greater than or equal to 0.01 wt % and less than or equal to 2.0 wt % Cu₂O.

4. The glass-ceramic of claim 3, wherein the precursor glass comprises greater than 0 wt % and less than or equal to 2 wt % CaO.

5. The glass-ceramic of claim 3, wherein the precursor glass comprises than 0 wt % and less than or equal to 1 wt % K₂O.

6. The glass-ceramic of claim 3, wherein the precursor glass comprises greater than 0 wt % and less than or equal to 1 wt % Na₂O.

7. The glass-ceramic of claim 3, wherein the precursor glass comprises greater than or equal to 0.01 wt % to less than or equal to 2 wt % CuO.

8. The glass-ceramic of claim 3, wherein the precursor glass is free of CuO.

9. The glass-ceramic of claim 3, wherein the precursor glass comprises on optical basicity of greater than or equal to 0.47 and less than or equal to 0.49.

10. The glass-ceramic of claim 1, wherein the phase assemblage further comprises less than 10 wt % lithium metasilicate.

11. A method of forming a colored glass-ceramic, the method comprising:
flowing oxygen and fuel to a burner of a melter and combusting the oxygen and the fuel to heat the melter, wherein a ratio of oxygen to fuel is less than 2.7:1 and greater than or equal to 1.8:1;
heating glass batch materials in the melter to form molten glass;
forming the molten glass into a precursor glass with a forming apparatus, wherein the precursor glass comprises:
greater than or equal to 65 wt % and less than or equal to 80 wt % SiO₂;
greater than or equal to 1 wt % and less than or equal to 15 wt % Al₂O₃;
greater than or equal to 8 wt % and less than or equal to 15 wt % Li₂O;
greater than or equal to 1 wt % and less than or equal to 4 wt % P₂O₅;
greater than or equal to 2 wt % and less than or equal to 12 wt % ZrO₂;
greater than or equal to 0.01 wt % and less than or equal to 0.6 wt % SnO; and
greater than or equal to 0.01 wt % and less than or equal to 2.0 wt % Cu₂O; and
ceramming the precursor glass into a glass-ceramic.

12. The method of claim 11, wherein the precursor glass comprises:
greater than 0 wt % and less than or equal to 2 wt % CaO;
greater than 0 wt % and less than or equal to 1 wt % K₂O; and
greater than 0 wt % and less than or equal to 1 wt % Na₂O.

13. The method of claim 11, wherein the precursor glass comprises greater than or equal to 0.01 wt % to less than or equal to 2 wt % CuO.

14. The method of claim 11, wherein the precursor glass is free of CuO.

15. The method of claim 11, wherein the precursor glass comprises on optical basicity of greater than or equal to 0.47 and less than or equal to 0.49.

16. The method of claim 11, wherein the glass-ceramic comprises a phase assemblage comprising:
35 wt % to 60 wt % of a petalite crystalline phase;
20 wt % to 60 wt % of a lithium disilicate crystalline phase; and
5 wt % to 20 wt % of a residual amorphous glass phase; and
copper metal nanoparticles dispersed in the residual amorphous glass phase.

17. The method of claim 16, wherein a size distribution of the copper metal nanoparticles in the glass-ceramic is such that a peak position of a largest dimension of the copper metal nanoparticles is in a range from greater than or equal to 20 nm to less than or equal to 40 nm.

18. The method of claim 11, wherein the glass-ceramic appears red in color and comprises transmittance color coordinates in CIE LAB color space of:
L* greater than or equal to 0 and less than or equal to 100;
a* greater than or equal to −23 and less than or equal to 62; and
b* greater than or equal to −10 and less than or equal to 60.5 at an article thickness of 0.55 mm for a CIE illuminant D65 under SCI UVC conditions and a 10 degree observer angle.

19. The method of claim 11, wherein the batch materials includes a sulfate fining agent in an amount from greater than or equal to 0.1 wt % to less than or equal to 0.5 wt %.

20. A glass-ceramic comprising:
a phase assemblage comprising:
35 wt % to 60 wt % of a petalite crystalline phase;
20 wt % to 60 wt % of a lithium disilicate crystalline phase; and
5 wt % to 20 wt % of a residual amorphous glass phase; and
wherein a composition of the glass-ceramic, expressed in terms of representative oxides, comprises SO₃ in a detectable amount greater than 0 wt % and less than or equal to 0.4 wt % of the composition.
